(19) United States
(12) Patent Application Publication
(10) Pub. No.: US 2023/0040421 A1
(43) Pub. Date: Feb. 9, 2023

(54) USER EQUIPMENT AND METHOD FOR PERFORMING CONFIGURED GRANT BASED SMALL DATA TRANSMISSION

(71) Applicant: FG Innovation Company Limited, Tuen Mun (HK)

(72) Inventors: HSIN-HSI TSAI, Taipei (TW); HENG-LI CHIN, Taipei (TW); YUNG-LAN TSENG, Taipei (TW); MEI-JU SHIH, Taipei (TW)

(21) Appl. No.: 17/869,087

(22) Filed: Jul. 20, 2022

Related U.S. Application Data
(60) Provisional application No. 63/223,790, filed on Jul. 20, 2021.

(51) Int. Cl. H04W 72/14; H04L 1/18

(52) U.S. Cl. CPC H04W 72/14; H04L 1/1848

(57) ABSTRACT

A method and a user equipment (UE) for performing a Configured Grant-based Small Data Transmission (CG-SDT) is provided. The method includes performing an initial transmission of the CG-SDT via a first configured Uplink (UL) grant associated with a Hybrid Automatic Repeat Request (HARQ) process; determining whether a feedback from the BS has been received for the first configured UL grant associated with the HARQ process; and performing a retransmission for the initial transmission of the CG-SDT via a second configured UL grant if the feedback has not been received.

### CROSS-REFERENCE TO RELATED APPLICATION(S)

The present disclosure claims the benefit of and priority to U.S. Provisional Patent Application Ser. No. 63/223,790, filed on Jul. 20, 2021, entitled “UL TRANSMISSION FOR SMALL DATA TRANSMISSION PROCEDURE,” the content of which is hereby incorporated fully by reference herein into the present disclosure for all purposes.

### FIELD

The present disclosure is related to wireless communication, and more specifically, to a Configured Grant-based Small Data Transmission (CG-SDT) in a wireless communication system.

### BACKGROUND

Various efforts have been made to improve different aspects of wireless communication for cellular wireless communication systems, such as fifth-generation (5G) New Radio (NR), by improving data rate, latency, reliability, and mobility in these systems. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art, such as improvements in Configured Grant-based Small Data Transmission (CG-SDT) for wireless communication.

### SUMMARY

The present disclosure is related to a Configured Grant-based Small Data Transmission (CG-SDT) in a wireless communication system.

In a first aspect of the present disclosure, a method for a User Equipment (UE) to perform a Configured Grant-based Small Data Transmission (CG-SDT) to a Base Station (BS) is provided. The method includes performing an initial transmission of the CG-SDT via a first configured Uplink (UL) grant associated with a Hybrid Automatic Repeat Request (HARQ) process; determining whether a feedback from the BS has been received for the first configured UL grant associated with the HARQ process; and performing a retransmission for the initial transmission of the CG-SDT via a second configured UL grant if the feedback has not been received.

In an implementation of the first aspect, the initial transmission of the CG-SDT includes a Common Control Channel (CCCH) message.

In another implementation of the first aspect, the feedback is received on a Physical Downlink Control Channel (PDCCH) addressed to a Cell-Radio Network Temporary Identifier (C-RNTI).

In an implementation of the first aspect, the retransmission for the initial transmission of the CG-SDT is performed if the feedback is not received and a CG-SDT retransmission timer is configured and not running.

In an implementation of the first aspect, a Medium Access Control (MAC) layer of the UE indicates a failure of performing a Small Data Transmission (SDT) procedure to a Radio Resource Control (RRC) layer of the UE if a configured grant timer for the HARQ process expires and the feedback has not been received after the initial transmission of the CG-SDT.

In an implementation of the first aspect, the method further includes stopping a CG-SDT retransmission timer for the HARQ process if the UE receives a specific UL grant.

In an implementation of the first aspect, the specific UL grant is received on a Physical Downlink Control Channel (PDCCH) addressed to a Cell-Radio Network Temporary Identifier (C-RNTI).

In another implementation of the first aspect, the method further includes stopping a configured grant timer for the HARQ process if the UE receives a specific UL grant.

In an implementation of the first aspect, the specific UL grant is received on a Physical Downlink Control Channel (PDCCH) addressed to a Cell-Radio Network Temporary Identifier (C-RNTI).

In another implementation of the first aspect, the method further includes starting or restarting a CG-SDT retransmission timer for the HARQ process when the initial transmission of the CG-SDT or the retransmission for the initial transmission of the CG-SDT is performed.

In a second aspect of the present disclosure, a UE in a wireless communication system for performing a Configured Grant-based Small Data Transmission (CG-SDT) to a Base Station (BS) is provided. The UE includes at least one processor; and at least one memory coupled to the at least one processor, the at least one memory storing a computer-executable program that, when executed by the at least one processor, causes the UE to perform an initial transmission of the CG-SDT via a first configured Uplink (UL) grant associated with a Hybrid Automatic Repeat Request (HARQ) process; determine whether a feedback from the BS has been received for the first configured UL grant associated with the HARQ process; and perform a retransmission for the initial transmission of the CG-SDT via a second configured UL grant if the feedback has not been received.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a flowchart of an SDT procedure, according to an example implementation of the present disclosure.

FIG. 2 illustrates a communication diagram of an RA-based SDT, according to an example implementation of the present disclosure.

FIG. 3 illustrates a communication diagram of a CG-based SDT, according to an example implementation of the present disclosure.

FIG. 4 illustrates a timing diagram of a subsequent transmission period (or a subsequent transmission phase) of an SDT procedure, according to an example implementation of the present disclosure.

FIG. 5 illustrates a timing diagram of a UL transmission of a UE before receiving a feedback from a BS, according to an example implementation of the present disclosure.

FIG. 6 illustrates a timing diagram of a second UL transmission before receiving the feedback, according to an example implementation of the present disclosure.

FIG. 7 illustrates a timing diagram of a feedback reception failure, according to an example implementation of the present disclosure.

FIG. 8 illustrates a timing diagram of a second UL transmission after the timer expires, according to an example implementation of the present disclosure.

FIG. 9 illustrates a diagram of an internal-layer indication, according to an example implementation of the present disclosure.

FIG. 10 illustrates a diagram of a radio protocol stack, according to an example implementation of the present disclosure.

FIG. 11 illustrates a flowchart of a procedure for a UE to perform a CG-SDT, according to an example implementation of the present disclosure.

FIG. 12 is a block diagram illustrating a node for wireless communication, according to an implementation of the present disclosure.

### DESCRIPTION

Abbreviations used in this disclosure include:

| Abbreviation | Full name |
|---|---|
| 3GPP | 3rd Generation Partnership Project |
| ACK | Positive Acknowledgement |
| AS | Access Stratum |
| BS | Base Station |
| BSR | Buffer Status Report |
| BWP | Bandwidth Part |
| CBRA | Contention Based Random Access |
| CCCH | Common Control Channel |
| CE | Control Element |
| CFRA | Contention Free Random Access |
| CG | Configured Grant |
| CN | Core Network |
| CORESET | Control Resource Set |
| C-RNTI | Cell-Radio Network Temporary Identifier |
| CS-RNTI | Configured Scheduling-Radio Network Temporary |
| | Identifier |
| CSI | Channel State Information |
| CSS | Common Search Space |
| CP | Cyclic Prefix |
| DCI | Downlink Control Information |
| DFI | Downlink Feedback Information |
| DL | Downlink |
| DMRS | DeModulation Reference Signal |
| DRB | Data Radio Bearer |
| DRX | Discontinuous Reception |
| eNB | Evolved Node B |
| FR | Frequency Range |
| gNB | Next Generation Node B |
| HARQ | Hybrid Automatic Repeat Request |
| ID | Identifier/Identity |
| IE | Information Element |
| LCH | Logical Channel |
| LCP | Logical Channel Prioritization |
| MAC | Medium Access Control |
| MCG | Master Cell Group |
| MN | Master Node |
| Msg | Message |
| NACK | Negative Acknowledgement |
| NAS | Non-Access Stratum |
| NDI | New Data Indicator |
| NR | New Radio |
| NW | Network |
| NUL | Normal Uplink |
| OFDM | Orthogonal Frequency Division Multiplexing |
| PBCH | Physical Broadcast Channel |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHR | Power Headroom Reporting |
| PHY | Physical Layer |
| PRACH | Physical Random Access Channel |
| PSCell | Primary Secondary Cell |
| PUCCH | Physical Uplink Control Channel |
| PUSCH | Physical Uplink Shared Channel |
| PWS | Public Warning System |
| QCL | Quasi Co Location |
| QoS | Quality of Service |
| RA | Random Access |
| RA-RNTI | Random Access-Radio Network Temporary Identifier |
| RACH | Random Access Channel |
| RAR | Random Access Response |
| RAN | Radio Access Network |
| RB | Radio Bearer |
| Rel | Release |
| RF | Radio Frequency |
| RLC | Radio Link Control |
| RNA | RAN Notification Area |
| RNTI | Radio Network Temporary Identifier |
| RO | RACH Occasion |
| RRC | Radio Resource Control |
| RS | Reference Signal |
| RSRP | Reference Signal Received Power |
| RV | Redundancy Version |
| RX | Reception |
| SCell | Secondary Cell |
| SCG | Secondary Cell Group |
| SCS | Sub Carrier Spacing |
| SDAP | Service Data Adaptation Protocol |
| SDT | Small Data Transmission |
| SDU | Service Data Unit |
| SFN | System Frame Number |
| SI | System Information |
| SIB | System Information Block |
| SL | Sidelink |
| SN | Secondary Node |
| SPS | Semi-Persistent Scheduling |
| SR | Scheduling Request |
| SRB | Signaling Radio Bearer |
| SRS | Sounding Reference Signal |
| SpCell | Special Cell |
| SS | Search Space |
| SSB | SS/PBCH Block |
| SS-RSRP | Synchronization Signal- Reference Signal Received Power |
| SUL | Supplementary Uplink |
| TA | Timing Advance |
| TAT | Timing Advance Timer |
| TBS | Transport Block Size |
| TCI | Transmission Configuration Indicator |
| TRP | Transmission and Reception Point |
| TS | Technical Specification |
| Tx | Transmission |
| UCI | Uplink Control Information |
| UE | User Equipment |
| UL | Uplink |
| USS | UE-specific Search Space |
| URLLC | Ultra-Reliable and Low Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series, or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may include computer-executable instructions stored on computer-readable media, such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Application-Specific Integrated Circuits (ASICs), programmable logic arrays, and/or using one or more Digital Signal Processor (DSPs). Although some of the example implementations in the present disclosure are directed to software installed and executing on computer hardware, alternative example implementations implemented as firmware, as hardware, or as a combination of hardware and software are well within the scope of the present disclosure.

The computer-readable medium includes but is not limited to Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long-Term Evolution (LTE) system, an LTE-Advanced (LTE-A) system, or an LTE-Advanced Pro system) typically includes at least one BS, at least one UE, and one or more optional NW elements that provide connection towards an NW. The UE communicates with the NW (e.g., a CN, an Evolved Packet Core (EPC) NW, an Evolved Universal Terrestrial Radio Access NW (E-UTRAN), a Next-Generation Core (NGC), a 5G Core (5GC) Network or an Internet), through a RAN established by the BS/Cell.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but not limited to, a Node B (NB) as in the Universal Mobile Telecommunication System (UMTS), an eNB as in the LTE-A, a Radio NW Controller (RNC) as in the UMTS, a Base Station Controller (BSC) as in the Global System for Mobile communications (GSM)/GSM EDGE (Enhanced Data rates for GSM Evolution) Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

ABS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), LTE-A Pro, and a next generation RAT. However, the scope of the present disclosure should not be limited to the protocols previously disclosed.

The BS may be operable to provide radio coverage to a specific geographical area using a plurality of cells included in the RAN. The BS may support the operations of the cells. Each cell is operable to provide services to at least one UE within its radio coverage. More specifically, each cell (often referred to as a serving cell) may provide services to serve one or more UEs within its radio coverage (e.g., each cell schedules the DL and optionally UL resources to at least one UE within its radio coverage for DL and optionally UL packet transmissions). The BS may communicate with one or more UEs in the radio communication system through the plurality of cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or an SCG may be called a SpCell. A PCell may refer to the SpCell of an MCG. A PSCell may refer to the SpCell of an SCG. MCG refers to a group of serving cells associated with an MN, including the SpCell and optionally one or more SCells. SCG refers to a group of serving cells associated with a Secondary Node (SN), including the SpCell and optionally one or more SCells.

In some implementations, the UE may not have (LTE/NR) RRC connections with the concerned serving cells of the associated services. In other words, the UE may not have UE-specific RRC signal exchange with the serving cell. Instead, the UE may only monitor the DL synchronization signals (e.g., DL synchronization burst sets) and/or broadcast SI related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR supports flexible configurations for accommodating various next generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the CP, may also be used. Additionally, two coding schemes are considered for NR: (1) low-density parity-check (LDPC) code and (2) polar code. The coding scheme adaption may be configured based on the channel conditions and/or service applications.

It is also considered that in a transmission time interval of a single NR frame, at least DL transmission data, a guard period, and UL transmission data should be included. The respective portions of the DL transmission data, the guard period, and the UL transmission data should also be configurable, for example, based on the NW dynamics of NR. In addition, SL resources may also be provided in an NR frame to support ProSe services.

Any two or more than two of the following sentences, paragraphs, (sub)-bullets, points, actions, behaviors, terms, alternatives, aspects, examples, or claims described in the following invention(s) may be combined logically, reasonably, and properly to form a specific method.

Any sentence, paragraph, (sub)-bullet, point, action, behaviors, terms, alternatives, aspects, examples, or claims described in the following invention(s) may be implemented independently and separately to form a specific method.

Dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

SDT

In NR, until Rel-16, an RRC_INACTIVE state doesn't support data transmission (e.g., UL data transmission on a PUSCH and/or DL data transmission on a PDSCH). Hence, the UE needs to resume a connection (e.g., move to an RRC_CONNECTED state) for any DL reception and/or UL data transmission. A connection setup and a subsequently release to the RRC_INACTIVE state happens for each data transmission regardless of how small and infrequent the data packets are. This results in unnecessary power consumption and signaling overhead. Signaling overhead caused by transmission of small data packets for the UEs in the RRC_INACTIVE state is a general problem, and will become a critical issue, as the number of UEs increases in NR, not only for NW performance and efficiency but also for UE battery performance. In general, any device that has intermittent small data packets in the RRC_INACTIVE state will benefit from enabling small data transmission in the RRC_INACTIVE state. The key enablers for small data transmission in NR, e.g., the RRC_INACTIVE state, a 2-step RACH, a 4-step RACH, and/or a CG type-1 have already been specified as part of legacy. Thus, NR needs improvement to enable small data transmission in the RRC_INACTIVE state for NR.

An SDT may be a procedure that allows data transmission while the UE is in the RRC_INACTIVE state (e.g., without transitioning to the RRC_CONNECTED state). The SDT may be enabled on an RB basis and is initiated by the UE only if less than a configured amount of UL data awaits for transmission across all RBs (e.g., SRBs and/or DRBs), where the SDT is enabled and a measured RSRP in the cell is above a configured threshold.

The SDT is configured to either take place on a RACH (e.g., an RA-based SDT) or type 1 CG resources (e.g., a CG-based SDT). For the RACH, the NW may also consider whether the 2-step RA type and 4-step RA type can be used. When both the 2-step RA type and 4-step RA type can be used, the UE may select one of the RA types. When only the 2-step RA type can be used, the SDT may only be initiated if the criteria to select the 2-step RA type is also met.

Once the SDT is initiated, the SDT may continue as long as the UE is not explicitly directed to an RRC_IDLE state or the RRC_INACTIVE state (e.g., via an RRCRelease) or to the RRC_CONNECTED (e.g., via an RRCResume).

After an initial transmission of the SDT, subsequent transmissions may be handled depending on configured types of resources. In one example, when CG resources are used, the NW may schedule subsequent UL transmission using dynamic grants or next CG resource occasions. In another example, when RACH resources are used, the NW may schedule subsequent UL and DL transmissions using dynamic grants and/or assignments after completion of an RA procedure.

SDT Procedure

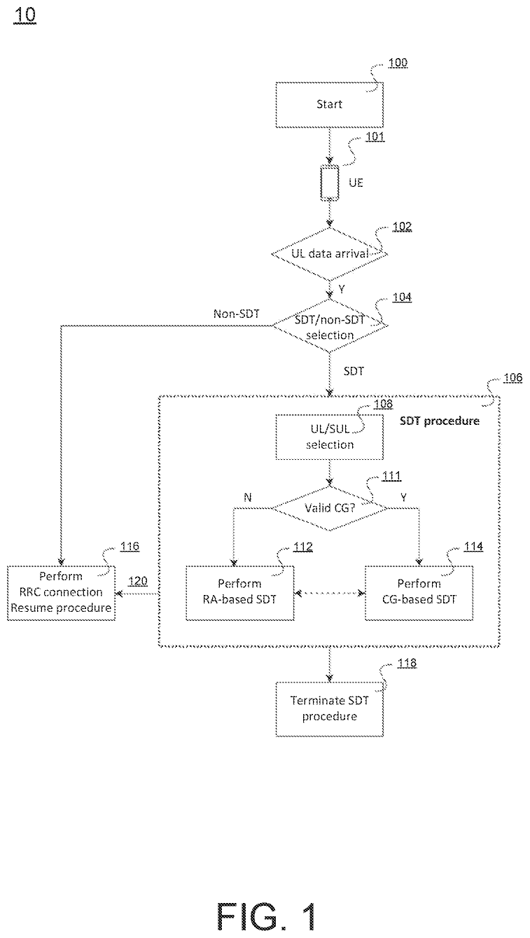

FIG. 1 illustrates a flowchart of an SDT procedure 10, according to an example implementation of the present disclosure. In some implementations, actions of the SDT procedure 10 are illustrated as separate actions represented as independent blocks. In some other implementations, these separate actions may not be construed as necessarily order dependent, where any two or more actions may also be performed and/or combined with each other or be integrated with other alternate methods, which is not limiting the scope of the implementation. Moreover, in some other implementations, one or more of the actions may be adaptively omitted.

As shown in FIG. 1, for action 101, the UE may be in the RRC_INACTIVE state. The UE may be configured with configurations for the SDT (e.g., via an IE sdt-Config and/or an IE sdt-ConfigCommon). The configurations for the SDT may be configured via an RRC release message (and/or via a suspend configuration), and/or via system information (e.g., an SIB). The configuration(s) for the SDT may include at least one of a RACH configuration (e.g., via an IE ra-SDT-config), a CG configuration (e.g., via an IE cg-SDT-config), configuration(s) for SRB/DRB used for the SDT, a DRB list (e.g., via an IE sdt-DRBList), and an SRB indication (e.g., via an IE SRB2Indication).

In action 102, UL data may be arrival for transmission. The UL data may be associated with a specific DRB/SRB/LCH. The specific DRB/SRB/LCH may be configured for the SDT. The specific DRB/SRB/LCH may be configured by a DRB list (e.g., via an IE sdt-DRBList) and/or an SRB indication (e.g., via an IE SRB2Indication). Then a UE may initiate a (resume) procedure for the SDT (e.g., an SDT procedure).

In action 104, the UE (or its MAC entity) may be configured by an RRC message with the SDT, and the SDT may be initiated by an RRC layer and/or a MAC layer. The SDT can be performed either by an RA procedure with a 2-step RA type or a 4-step RA type (e.g., an RA-SDT) or by a configured grant type 1 (e.g., a CG-SDT). For the SDT procedure, the UE (or its MAC entity) may consider the RBs configured with the SDT which are suspended for data volume calculation.

Specifically, the UE may determine whether to initiate the SDT procedure in action 106 (e.g., initiate the SDT procedure, initiate the RA procedure for the SDT, and/or initiate the SDT procedure with CG) or initiate a non-SDT procedure (e.g., an RRC connection resume procedure) in action 116, (e.g., by initiating an RA procedure for CCCH logical channel). The UE may determine whether to initiate the SDT procedure in action 106 or initiate a non-SDT procedure based on one or more criteria, e.g., DRB/SRB, data volume, and/or RSRP, etc.

In one implementation, the UE may initiate the SDT procedure when/after at least one LCH/DRB/SRB is configured for the SDT and has pending data. For example, data is available for transmission for only those LCHs/DRBs/SRBs for which SDT is enabled. The LCH/DRB/SRB configured for the SDT may be resumed/re-established when the UE initiates the SDT procedure. Alternatively, the UE may initiate the RRC connection resume procedure when/after at least one LCH/DRB/SRB is not configured for SDT and has pending data.

In one implementation, the UE may initiate the SDT procedure if a data volume for transmission (e.g., for the SDT) is lower than a configured threshold for the SDT. The data volume may only count the (total) volume of the LCHs/DRBs/SRBs configured for the SDT. Alternatively, the UE may initiate an RRC connection resume procedure if a data volume for transmission (e.g., for the SDT) is higher than a configured threshold for the SDT.

In one implementation, the UE may initiate the SDT procedure if an RSRP is larger than a configured RSRP threshold for the SDT. Alternatively, the UE may initiate the RRC connection resume procedure if an RSRP is lower than a configured RSRP threshold for the SDT.

In action 106, there may be two types of the SDT procedure. One is based on the RA procedure (e.g., the 2-step RA or the 4-step RA), e.g., an RA-based SDT (or referred to as an RA-SDT) in action 112. The other is based on a CG (e.g., a type 1 CG), e.g., a CG-based SDT (or referred to as a CG-SDT) in action 114. The UE may transmit the UL data (e.g., small data) via an MSG3, an MSGA, a CG resource, and/or PUSCH resources during the SDT procedure.

In action 108, the UE may perform UL carrier selection (e.g., if an SUL is configured in the cell, a UL carrier may be selected based on an RSRP threshold). After the UL carrier selection, the UE may perform the SDT procedure on the selected UL carrier (e.g., either a UL or an SUL).

In one implementation, the SDT procedure may be as introduced in Table 1.

TABLE 1
The UE/MAC entity may:

| 1> | if the data volume of the pending UL data across all logical channels configured for the SDT is less than or equal | |
|---|---|---|
| | to an sdt-DataVolumeThreshold: | |
| 2> | if the Serving Cell for the SDT is configured with the SUL as specified in TS 38.331; and | |
| 2> | if the RSRP of the DL pathloss reference is less than an sdt-RSRP-ThresholdSSB-SUL: | |
| | 3> | select the SUL carrier. |
| 2> | else: | |
| | 3> | select the NUL carrier. |

NOTE: the procedure needs to be improved when sdt-RSRP-ThresholdSSB-SUL is not configured

| 2> | if the RSRP of the DL pathloss reference is higher than an sdt-RSRP-Threshold, if configured: | |
|---|---|---|
| | 3> | if the CG type 1 is configured for the SDT, and the CG type 1 resource is valid: |
| | | 4> initiate the SDT with the CG type 1 on the selected UL carrier; |
| | | 4> indicate to the upper layer that conditions for initiating SDT are fulfilled. |
| | 3> | else if RA Resources are configured for the SDT: |
| | | 4> initiate the RA procedure on the selected UL carrier for the SDT; |
| | | 4> indicate to the upper layer that conditions for initiating the SDT are fulfilled. |
| | 3> | else: |
| | | 4> initiate the RA procedure for CCCH logical channel (e.g., not for the SDT); |

| | |
|---|---|
| 2> | else: |

3>initiate the RA procedure for CCCH logical channel (e.g., not for the SDT);

| | |
|---|---|
| 1> | else: |
| 2> | initiate the RA procedure for CCCH logical channel (e.g., not for the SDT); |

In action 111, the UE may determine whether a CG resource/configuration is valid (during the SDT procedure) based on one or more of the following scenarios/criterions/implementations.

In one implementation, the UE may determine whether a CG resource/configuration is valid based on whether the associated beam is valid. Whether the associated beam is valid may be based on an RSRP threshold. The RSRP threshold may be configured in the RRC release message and/or the CG configuration. In one example, if there is at least one beam with an RSRP being above the RSRP threshold, the UE may consider the CG resource/configuration is valid. If there is no beam with an RSRP above the RSRP threshold, the UE may consider the CG resource/configuration is not valid.

In another implementation, the UE may determine whether a CG resource/configuration is valid based on whether a TA is valid. The UE may determine the CG resource/configuration is valid while the TA is valid. If the TA is not valid, the UE may consider the CG resource/configuration is not valid. In one example, whether a TA is valid may be based on a TA timer. Specifically, the UE may consider the TA is valid while the TA timer is running. The UE may consider the TA is not valid while the TA timer is not running. The (parameter of) TA timer may be configured in the RRC release message and/or the CG configuration. In another example, whether a TA is valid may be based on an RSRP change volume. Specifically, the UE may consider the TA is not valid if the RSRP change is higher than a threshold. The threshold (for the RSRP change) may be configured in the RRC release message and/or the CG configuration.

In one implementation, validation for the SDT using the CG may be as introduced in Table 2.

TABLE 2
The UE may consider the time alignment value for the SDT using a CG type 1 to be valid when the following conditions are
fulfilled:

| | |
|---|---|
| 1> | compared to the stored DL pathloss reference RSRP value, the RSRP has not increased by more than a cg-SDT- |
| | RSRP-ChangeThresholdIncrease, if configured; and |
| 1> | compared to the stored DL pathloss reference RSRP value, the RSRP has not decrease by more than a cg-SDT- |
| | RSRP-ChangeThresholdDecrease, if configured |

In some implementations, the UE may determine whether a CG resource/configuration is valid based on whether the CG configuration is configured. In one example, when the CG resource configuration is (re-)initialized, the CG resource configuration may be valid. In another example, when the CG resource configuration is released/suspended, the CG resource configuration may be invalid. In another example, the CG resource configuration may be configured in the RRC release message.

In some implementations, the UE may determine whether the CG resource/configuration is valid based on whether a timer (e.g., an SDT failure detection timer) is running. The timer may be configured in the RRC release message and/or the CG configuration. In one example, the UE may determine that the CG resource/configuration is valid while the timer is running. The UE may determine that CG resource/configuration is not valid while the timer is not running or when the timer expires. The timer may be used to detect a failure of the SDT. The timer may be (re-)started upon transmission of UL data when the UE is in the RRC_INACTIVE state. The timer may be (re-)started upon transmission of small data. The timer may be (re-)started upon transmission of an RRC resume request. The timer may be stopped upon reception of an RRCResume, an RRCSetup, an RRCRelease, an RRCRelease with suspendConfig or an RRCReject message, a cell re-selection and upon abortion of a connection establishment by upper layers. When the timer expires, the UE may enter the action upon going to the RRC_IDLE state (e.g., with a specific RRC resume cause).

In action 112, if the UE determines that the CG resource/configuration is not valid, e.g., one of the criteria for CG validity is not satisfied, the UE may perform the RA-based SDT. For example, the UE may initiate an RA procedure (for the SDT). The RA procedure may be either the 2-step type or the 4-step type based on the selection by the UE (e.g., according to an RSRP threshold). The UE may perform the transmission of the RA preamble, e.g., via the preamble/RA resource/PRACH resource that is configured for the SDT. The UE may perform UL transmission (e.g., small data) via an MSG3/MSGA.

In action 114, if the UE determines that the CG is valid, e.g., the criteria for CG validity is satisfied, the UE may perform the CG-based SDT. For example, the UE may perform UL transmission (for small data) via the CG resource.

In action 116, if the criteria (e.g., DRB/SRB, data volume, and/or RSRP) for initiating the SDT procedure is not satisfied, the UE may initiate the non-SDT procedure (e.g., an RRC connection resume procedure), e.g., the UE may initiate the RA procedure for a CCCH logical channel.

In action 118, the SDT procedure may be terminated/stopped/completed by an indication from the NW (e.g., via an RRC release message), by a timer (e.g., an SDT failure detection timer being expiring), and/or by a counter (e.g., the value of the counter reaching a maximum value).

In action 120, the SDT procedure may fallback/switch to the non-SDT procedure (e.g., an RRC connection resume procedure). For example, when the UE receives an indication (e.g., a fallback indication) from the NW (e.g., an RRC resume/RRC release message), the UE may stop/terminate/complete the SDT procedure and then may initiate an RRC connection resume procedure. For another example, if the initial UL transmission (e.g., in MSGA/MSG3/CG resources) fails a configured number of times, the UE may stop/terminate/complete the SDT procedure and then may initiate an RRC connection resume procedure.

RA-Based SDT (RA-SDT)

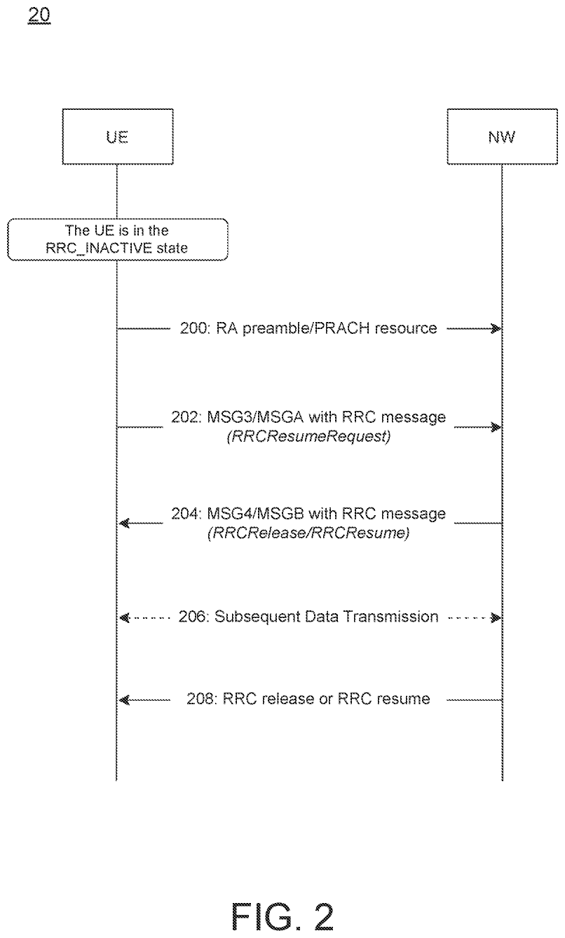

FIG. 2 illustrates a communication diagram of an RA-based SDT 20, according to an example implementation of the present disclosure.

As shown in FIG. 2, when a UE in the RRC_INACTIVE state has UL data available for transmission and/or an SDT procedure has been initiated, in action 200, the UE may initiate an RA-based SDT procedure for the transmission of the UL data (e.g., in a case that the CG is considered as not valid). The UE may select either a 4-step RA type or a 2-step RA type. Moreover, the preamble/PRACH resource for the RA-based SDT procedure (e.g., an RA preamble/a PRACH resource configured for the SDT) and the normal RA procedure (e.g., an RA preamble not configured for the SDT) may be different. Here, the UE may select the preamble/PRACH resource configured for the SDT.

In action 202, after transmitting the RA preamble, the UE may transmit an RRC message (e.g., a CCCH message), MAC CE(s), and/or UL data through an MSG3 (when the 4-step RA type is selected) or an MSGA (when the 2-step RA type is selected). The RRC message may be an RRCResumeRequest message. In addition to the RRC message, MAC CE (e.g., a BSR) and UL data (e.g., data associated with DRB(s) for the SDT) may be included in the MSG3/MSGA as well.

In action 204, once the MSG3/MSGA is transmitted, the UE may monitor (e.g., Temporary C-RNTI)/C-RNTI/RA-RNTI/MSGB-RNTI for an MSG4 or an MSGB, in which the contention resolution ID will be carried. In addition, the NW may transmit an RRC message in the MSG4/MSGB. The RRC message may be an RRCRelease message (with a suspendConfig IE) or an RRCResume message. The UE may stay in the RRC_INACTIVE state if the UE receives an RRCRelease message (with the suspendConfig IE) or enters into the RRC_CONNECTED state if the UE receives an RRCResume message.

In action 206, once the RA procedure for the SDT is successfully completed, the UE may monitor a specific RNTI (e.g., C-RNTI) on a specific SS for subsequent data transmission. The subsequent data transmission may be the transmission of multiple UL and/or DL data packets as part of the SDT procedure without transitioning to the RRC_CONNECTED state (e.g., the UE is still in the RRC_INACTIVE state). The UE may monitor a PDCCH via a specific RNTI (e.g., a C-RNTI) to receive a dynamic scheduling for UL and/or DL new transmission and/or the corresponding retransmission. The UE may monitor the PDCCH via a UE-specific RNTI (e.g., a C-RNTI) to receive the dynamic scheduling for the retransmission of the UL transmission via a CG resource.

In action 208, the NW may send an RRC release (with a suspendconfig) message to keep the UE in the RRC_INACTIVE state or have the UE transition to the RRC_IDLE state. Alternatively, the NW may send an RRC resume message to have the UE transition to the RRC_CONNECTED state. Once the RRCRelease message (with the suspendConfig IE) is received, the UE may terminate the SDT procedure based on the RRCRelease message, and/or stop monitoring the C-RNTI, and/or stay in the RRC_INACTIVE state.

CG Based-SDT (CG-SDT)

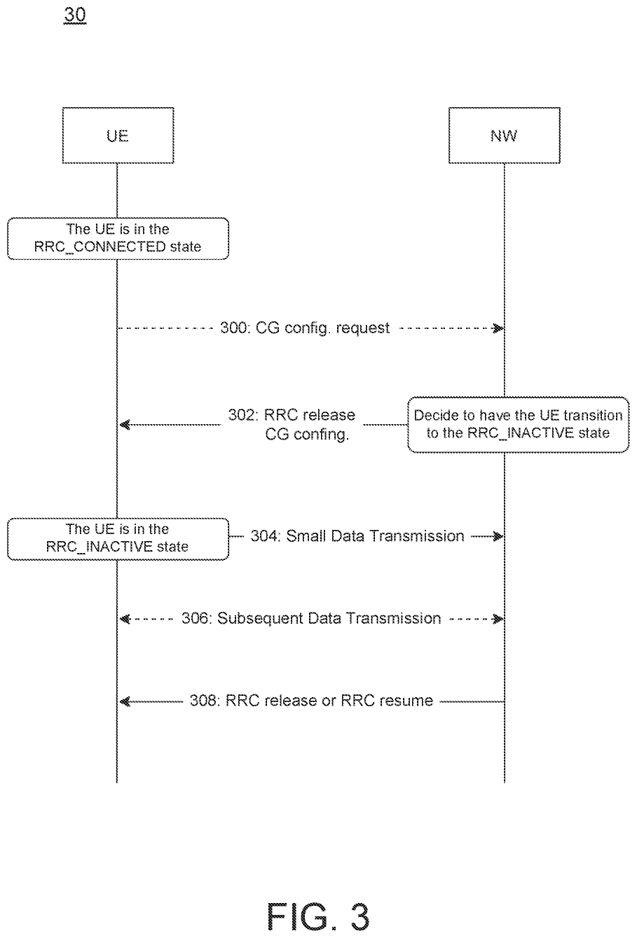

FIG. 3 illustrates a communication diagram of a CG-based SDT 30, according to an example implementation of the present disclosure.

As shown in FIG. 3, when the UE is in the RRC_CONNECTED state and/or in the RRC_INACTIVE state, in action 300, the UE may send a CG configuration request to the NW to indicate its preference on configuration with a CG for small data and/or for the RRC_INACTIVE state.

In action 302, the NW may decide to move the UE to the RRC_INACTIVE state by sending an RRCRelease message (including a suspendconfig IE) to the UE. The RRC release message may include at least a CG configuration to configure the CG resources to the UE. The CG configuration may include at least one of CG periodicity, a TBS, a number for the implicit release of the CG resources, a CG Timer, a retransmission timer, a number of a HARQ process reserved for the CG in the SDT, an RSRP threshold for an SSB selection and association between the SSB and CG resources, TA related parameters (e.g., a cg-SDT-TimeAlignmentTimer).

In action 304, the UE may perform the SDT procedure based on the CG resources (in the RRC_INACTIVE state) according to the CG configuration (e.g., those configured in action 302). For example, the UE may transmit UL data (e.g., small data) via the CG resource (during the SDT procedure).

In action 306, subsequent data transmission may be the transmission of multiple UL and/or DL packets as part of the SDT procedure without transitioning to the RRC_CONNECTED state (e.g., the UE is still in the RRC_INACTIVE state). The UE may monitor a PDCCH via a specific RNTI (e.g., a C-RNTI, a CS-r, and/or an SDT RNTI) on an SS (e.g., the one configured by a CG configuration) to receive a dynamic scheduling for UL and/or DL new transmission and/or the corresponding retransmission. The UE may monitor the PDCCH via the specific RNTI to receive the dynamic scheduling for the retransmission of the CG. The UE may also perform the subsequent data transmission via the CG resource according to the CG configuration (e.g., the one configured in action 302).

In action 308, the NW may send an RRC release (with a suspendconfig) message to keep the UE in the RRC_INACTIVE state or have the UE transition to the RRC_IDLE state. Alternatively, the NW may send an RRC resume message to have the UE transition to the RRC_CONNECTED state. Once the RRCRelease message (with the suspendConfig IE) is received, the UE may terminate the SDT procedure based on the RRCRelease message, and/or stop monitoring the specific RNTI, and/or stay in the RRC_INACTIVE state.

Subsequent Transmission Period

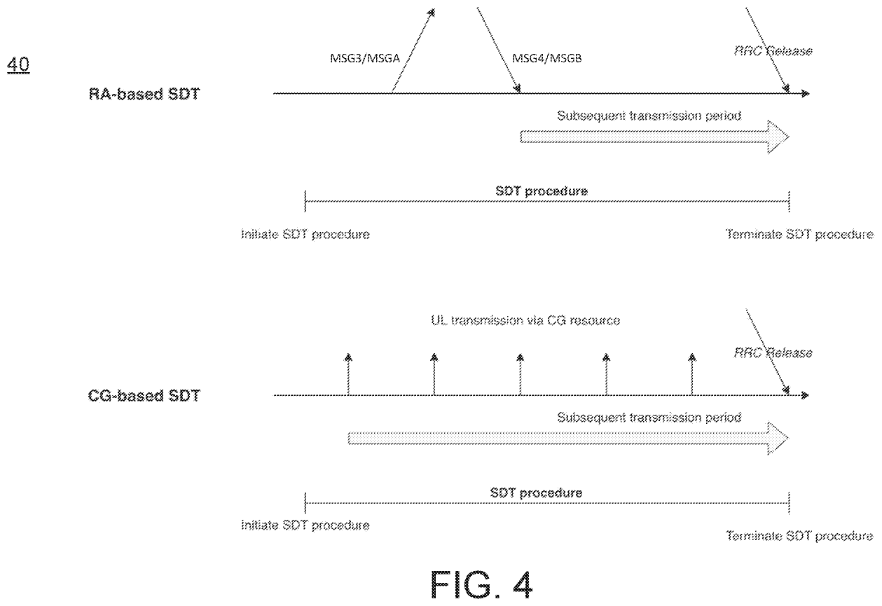

FIG. 4 illustrates a timing diagram 40 of a subsequent transmission period (or a subsequent transmission phase) of an SDT procedure, according to an example implementation of the present disclosure. The duration of the subsequent transmission period may be implemented in the following.

In one implementation, the subsequent transmission period may be determined as a timing period during an (RA-based and/or CG-based) SDT procedure. For example, the subsequent transmission period may be a timing period while the SDT procedure is ongoing. For example, the subsequent transmission period may be a timing period while/after a CG configuration is configured/initiated (and the CG configuration is not released).

In one implementation, the subsequent transmission period may be determined as initialization when/after the UE initiates an SDT procedure.

In one implementation, the subsequent transmission period may be determined as initialization when/after the UE considers a contention resolution is successful for an RA procedure and/or after the UE considers the RA procedure is successfully completed. The RA procedure may be an RA-based SDT. The RA procedure may be initiated for the SDT.

In one implementation, the subsequent transmission period may be determined as initialization when/after the CG configuration is configured/(re-)initialized. In one example, the CG configuration may include a parameter that is used to indicate an SDT scheduling.

In one implementation, the subsequent transmission period may be determined as initialization when/after the CG configuration is considered as valid.

In one implementation, the subsequent transmission period may be determined as initialization when/after the UE transmits a UL message. More details are introduced in the following examples.

In one example, the UL message may be transmitted via the MSG1/MSG3/MSGA/CG resource/UL resource scheduled by the MSG2/MSGB/MSG4 (during the SDT procedure) or on the UL resource being (pre-)configured as part of the SDT configuration. In one example, the UL message may include an RRC resume request message (e.g., an RRCResumeRequest, an RRCResumeRequest1, and/or a CCCH message for the SDT). In one example, the UL message may include small data (e.g., UL data associated with a specific SRB/DRB/LCH for the SDT). In one example, the UL message may include a MAC CE (e.g., a BSR MAC CE). In one implementation, the subsequent transmission period may be determined as initialization when/after the UE receives a response from the NW. In one example, the response may be an MSG2/MSG4/MSGB and/or a response for a UL transmission via the CG resource. In one example, the response may be used for the contention resolution, e.g., for an RA procedure. In one example, the response may include an (HARQ/RRC) ACK/NACK message, and/or DFI, e.g., for (the first) UL transmission via the CG resource. In one example, the response may include a UL grant/DL assignment for a new transmission/retransmission. The response may be a PDCCH addressed to an RNTI (e.g., a C-RNTI, a CS-RNTI, a dedicated RNTI, an RNTI for the SDT, and/or an RNTI for the CG). In one example, the response may indicate a UL grant for a new transmission for the HARQ process used for the transmission of a UL transmission for small data (e.g., the UL message). In one example, the response may include a specific command, e.g., a TA command MAC CE. In one example, the response may include an RRCResume, an RRCSetup, an RRCRelease, an RRCRelease with SuspendConfig, an RRCReestablishment, an RRCReconfiguration, and/or an RRCReject, etc.

In one implementation, the subsequent transmission period (and/or the SDT procedure) may be terminated/stopped when/after the SDT procedure is terminated.

In one implementation, the subsequent transmission period (and/or the SDT procedure) may be terminated/stopped when/after the CG configuration is released/suspended/cleared.

In one implementation, the subsequent transmission period (and/or the SDT procedure) may be terminated/stopped when/after the CG configuration is considered as invalid.

In one implementation, the subsequent transmission period (and/or the SDT procedure) may be terminated/stopped when/after the UE receives an indication from the NW.

In one example, the indication may include an RRCResume, an RRCSetup, an RRCRelease, an RRCRelease with SuspendConfig, an RRCReestablishment, and/or an RRCReject, etc. The indication may be a PDCCH addressed to a RNTI (e.g., a C-RNTI, a CS-RNTI, a dedicated RNTI, an RNTI for the SDT, and/or an RNTI for the CG). The indication may indicate to the UE to terminate the SDT procedure and/or the subsequent transmission period, e.g., based on a field of the indication. The indication may indicate to the UE to initiate an RRC procedure (e.g., an RRC connection resume procedure, an RRC establishment procedure, and/or an RRC reestablishment procedure). The indication may indicate to the UE to switch/fallback the types for the SDT, e.g., the type may be the RA-based SDT, the CG-based SDT, the 2-step RA, the 4-step RA, etc. The indication (with a specific value, e.g., ‘TRUE’ or ‘FALSE’) may be included in SI (e.g., a SIB) to indicate that CG transmission in the RRC_INACTIVE state is no longer supported in the cell. For example, when the UE receives the indication (with a specific value, e.g., ‘TRUE’ or ‘FALSE’), the UE may release/suspend the CG configuration(s).

In one implementation, the subsequent transmission period (and/or the SDT procedure) may be terminated/stopped when/after a timer expires. More details are introduced in the following examples.

In one example, the timer may be an SDT failure/problem detection timer. In one example, the timer may be specifically configured for the SDT. The value of the timer may be configured via an RRC release message. The value of the timer may be configured via an RRC release message with a suspend configuration. The value of the timer may be configured via a configuration for the SDT. The value of the timer may be configured via a RACH configuration for the SDT. The value of the timer may be configured via a CG configuration for the SDT. The value of the timer may be configured via an IE UE-TimersAndConstants. The value of the timer may be configured via SI (e.g., a SIB). In one example, the timer may be a TA timer, an ra-ResponseWindow, an msgB-Response Window, an ra-ContentionResolutionTimer, a configuredGrantTimer, a cg-RetransmissionTimer, a drx-onDurationTimer, a drx-InactivityTimer, a drx-RetransmissionTimerDL, a drx-RetransmissionTimerUL, a T300, a T301, a T302, a T304, a T310, a T311, a T312, a T316, a T319, a T320, a T321, a T322, a T325, a T330, a T331, a T342, a T345, and/or a new Tx. In one example, the timer may be used for monitoring a response (e.g., for an ACK/NACK). The timer may be a response window. In one example, the timer may be used for receiving a PDCCH/scheduling (e.g., for new transmission or retransmission) from the NW.

In one implementation, the subsequent transmission period may be terminated/stopped when/after the UE enters into the RRC_IDLE state or the RRC_CONNECTED state, e.g., from the RRC_INACTIVE state.

In one implementation, the subsequent transmission period may be terminated/stopped/released when/after the UE performs cell selection/reselection.

In one implementation, the subsequent transmission period may be terminated/stopped upon abortion of a connection establishment by upper layers.

In one implementation, the subsequent transmission period may be terminated/stopped upon an RNA update.

In one implementation, the subsequent transmission period may be terminated/stopped when/after the UE establishes/resumes an RRC connection from the RRC_INACTIVE state on a cell that is different from the cell where the CG configuration was provided.

In one implementation, the subsequent transmission period may be terminated/stopped when/after the UE initiates an RRC re-establishment procedure. For example, the subsequent transmission period may be terminated/stopped after the UE sends an RRCReestablishmentRequest to the NW.

In one implementation, the subsequent transmission period may be terminated/stopped when/after the UE is indicated, by the NW, to perform a carrier switching (e.g., from a NUL to an SUL, or vice versa).

In one implementation, the subsequent transmission period may be terminated/stopped when/after the UE is indicated, by the NW, to perform a (UL/DL) BWP switching.

In the subsequent transmission period, the UE may need to monitor the PDCCH, e.g., to receive the possible (DL and/or UL) scheduling from the NW. The UE may monitor the PDCCH (during the SDT procedure and/or during the subsequent transmission period) based on an SS, a CORESET, and/or an RNTI. For example, the UE may monitor the PDCCH addressed to the C-RNTI after successful completion of the RA procedure for the SDT.

In some implementations, the SS may include at least one of the following options.

Option 1: CSS

In one example, the CSS may be the common search space(s) configured in a PDCCH-ConfigCommon, the type-1 PDCCH CSS set configured by an ra-SearchSpace, the type-3 PDCCH CSS set, search space zero, a new common Search Space set configured via SI (e.g., a SIB) or an RRC release message, search space with parameters of the search space(s) configured in the initial BWP, etc.

Option 2: USS Set

In one example, the USS set may be a UE-specific Search Space set configured via an RRC Release message, a UE-specific Search Space set configured via the MSG4/MSGB, a UE-specific search space set configured via a PDCCH-Config, a UE-specific search space set configured via configuration(s) for the SDT, a search space with ID other than 0-39, a search space set identified as a specific set for the SDT, etc.

In some implementations, the CORESET may include at least one following options.

Option 1: Common CORESET

In one example, the common CORESET may be CORESET 0, CORESET other than CORESET 0, etc.

Option 2: UE-Specific CORESET Configuration

In one example, the UE-specific CORESET configuration may be a UE-specific CORESET configured via an RRC Release message, a UE-specific CORESET configured via the MSG4/MSGB, a UE-specific CORESET configured via configuration(s) for the SDT, a CORESET with ID other than 0-14, etc.

In some implementations, the RNTI may be a C-RNTI, a CS-RNTI, an SDT-RNTI, an RNTI for the SDT, an RNTI for the CG, etc.

Examples of some selected terms are provided as follows.

UE: This may be referred to as a PHY/MAC/RLC/PDCP/SDAP/RRC/AS/NAS layer/entity. Also, the PHY/MAC/RLC/PDCP/SDAP/RRC/AS/NAS layer/entity may be referred to the UE.

NW: This may be a network node, a TRP, a cell (e.g., an SpCell, a Pcell, a PSCell, and/or an Scell), an eNB, a gNB, and/or a BS.

Serving Cell: A Pcell, a PSCell, or an Scell. The serving cell may be an activated or a deactivated serving cell.

SpCell: For Dual Connectivity operation, this term refers to the Pcell of the MCG or the PSCell of the SCG depending on if the MAC entity is associated to the MCG or the SCG, respectively. Otherwise, the term refers to the Pcell.

The terms “RA-based SDT” and “RA-SDT” may be interchangeably used in some implementations of the present disclosure.

The terms “CG-based SDT” and “CG-SDT” may be interchangeably used in some implementations of the present disclosure.

The terms “initiate”, “trigger”, “apply”, “store”, “perform” and “start” may be interchangeably used in some implementations of the present disclosure.

The terms “terminate”, “stop”, “release”, “suspend”, “discard”, “end”, “complete”, “abort”, and “cancel” may be interchangeably used in some implementations of the present disclosure.

The terms “period”, “process”, “phase”, and “duration” may be interchangeably used in some implementations of the present disclosure.

The terms “resource” and “occasion” may be interchangeably used in some implementations of the present disclosure.

The terms “ongoing”, “running”, and “pending” may be interchangeably used in some implementations of the present disclosure.

The terms “beam”, “SSB”, and “CSI-RS” may be interchangeably used in some implementations of the present disclosure.

The terms “select” and “determine” may be interchangeably used in some implementations of the present disclosure.

Before Receiving the Feedback for the First UL Transmission

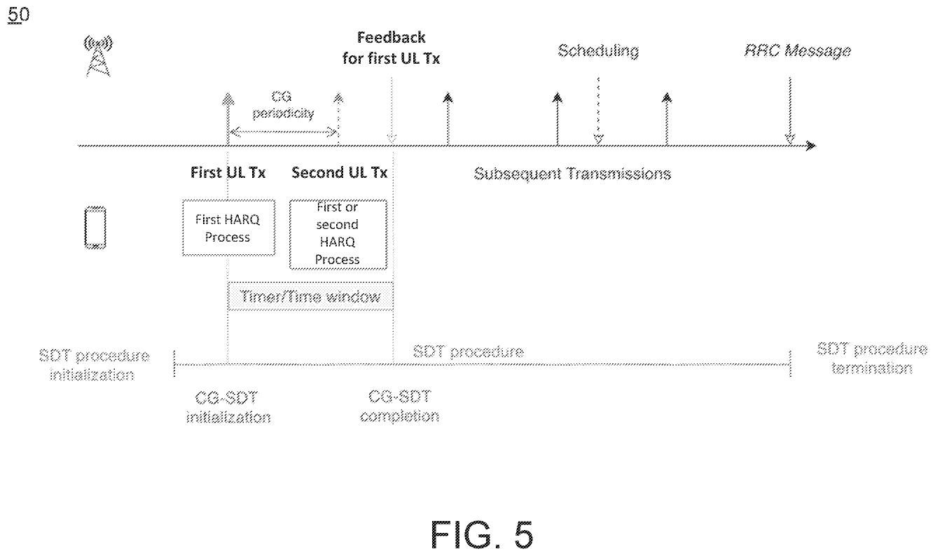

FIG. 5 illustrates a timing diagram of a UL transmission 50 of a UE before receiving a feedback from a BS, according to an example implementation of the present disclosure. As shown in FIG. 5, when/after a UE initiates an SDT procedure (and/or selects a UL carrier for the SDT procedure), the UE may determine to initiate/trigger a CG-SDT procedure (e.g., if at least one of the SSBs with an SS-RSRP above a cg-SDT-RSRP-ThresholdSSB is available).

In some implementations, when/after the UE initiates/triggers a CG-SDT procedure, the UE may perform at least one of the following actions/operations:

select/determine an SSB (e.g., an SSB with an SS-RSRP above a cg-SDT-RSRP-ThresholdSSB);
select/determine a CG configuration (e.g., a CG type 1 configuration on a BWP of the selected UL carrier associated with the selected SSB);
select/determine a CG occasion (e.g., corresponding to the selected SSB and the selected CG configuration); and
select/determine a first HARQ process for the CG occasion, where the CG occasion may be a PUSCH resource occasion.

In some implementations, when/after the UE selects/determines at least one of the SSB, the CG configuration, the CG occasion, and the first HARQ process, the UE may initiate/perform a first UL transmission using the first HARQ process on the CG occasion (during the CG-SDT procedure and/or the SDT procedure).

In one example, the first UL transmission may be a very first UL transmission after initiating the SDT procedure and/or after initiating the CG-SDT procedure.

In one example, the first UL transmission may include an RRC message (e.g., an RRC connection resume request message and/or a CCCH message), a MAC CE (e.g., a BSR, a PHR, etc.), UL data (e.g., data associated with RBs for the SDT), and/or padding bits, etc.

In one example, the first UL transmission may be an initial/new transmission.

In some implementations, when/after the UE initiates/performs the first UL transmission using the first HARQ process on the CG occasion, the UE may (re-)start a timer (for the HARQ process). While the timer is running, the UE may monitor a PDCCH addressed to a specific RNTI (e.g., a C-RNTI, a CS-RNTI, an SDT-RNTI, a cg-SDT-RNTI, etc.) on a specific SS (e.g., an SS configured in the CG configuration for the SDT).

In one example, the timer may be used for monitoring the PDCCH to receive/detect the feedback (for the first UL transmission).

In one example, the timer may be a timer configured in the CG configuration for the SDT.

In one example, the timer may be a timer configured in the SDT configuration.

In one example, the timer may be a timer configured by an RRC release (with or without a suspend configuration) message.

In one example, the timer may be a timer for a CG-SDT, an SDT timer, a DRX timer (e.g., a drx inactivity timer, a drx retransmission timer), a CG timer, a CG retransmission timer, a new T319 timer, and/or an SDT failure detection timer, etc.

In one example, the timer may be a time window, e.g., a response window.

In one example, the timer may be operated per MAC entity and/or per UE.

In one example, the timer may be operated individually for different HARQ processes. Specifically, when the UE performs a first UL transmission using a first HARQ process, the UE may (re-)start a first timer. When the UE performs a second UL transmission using a second HARQ process, the UE may (re-)start a second timer.

In one example, the unit of the timer may include one of a symbol, a slot, a subframe, a millisecond (ms), a second (s), etc.

In one example, the length of the timer may be configured in multiples of the periodicity of the CG.

In some implementations, when/after the UE monitors the PDCCH while the timer is running, the UE may attempt to receive/detect a feedback (for the first UL transmission and/or for the first HARQ process) from the BS.

In one example, the feedback may be a DL indication transmitted by the BS on the PDCCH, e.g., via a specific DCI, addressed to the specific RNTI (e.g., a C-RNTI, a CS-RNTI, an SDT-RNTI, a cg-SDT-RNTI, etc.).

In one example, the feedback may be a DL indication transmitted by the BS on the PDSCH, e.g., via a specific MAC CE and/or an RRC message.

In one example, the feedback may indicate a UL grant for a new transmission on the same HARQ process used for the first UL transmission (e.g., the first HARQ process). If the feedback indicates a UL grant for a new transmission on the same HARQ process used for the first UL transmission, the UE may consider it as an ACK.

In one example, the feedback may indicate an ACK/NACK information (for the first UL transmission and/or for the first HARQ process).

In one example, the feedback may indicate a DFI (for the first UL transmission and/or for the first HARQ process).

In some implementations, when/after the UE receives the feedback that indicates an ACK information (for the first UL transmission and/or for the first HARQ process) or indicates a UL grant for a new transmission on the same HARQ process used for the first UL transmission, the UE may perform at least one of the following actions/operations:

consider that the CG-SDT procedure is completed/successful;
perform the subsequent transmissions (e.g., via a CG or a DG); and
keep performing the SDT procedure (e.g., until the SDT procedure is terminated).

As shown in FIG. 5, it is possible that one or more CG UL resources/occasions may be located, in time domain, after transmitting the first UL transmission and before receiving the feedback. Since the UE has not received the feedback (for the first UL transmission) from the BS, the UE is not aware whether or not the BS has successfully received the first UL transmission for the CG-SDT. As a result, it is important whether the UE can perform a second UL transmission (using a second HARQ process) after transmitting the first UL transmission and before receiving the feedback.

In some implementations, the second HARQ process may be the same HARQ process as the first HARQ process.

In some implementations, the second HARQ process may be a different HARQ process from the first HARQ process.

In some implementations, the second UL transmission may be performed while the timer is running.

The Second UL Transmission being Prohibited

In some implementations, the UE may be prohibited from performing the second UL transmission.

In some implementations, the second UL transmission may include a second UL transmission and one or more of the following UL transmissions (after transmitting the first UL transmission and/or before receiving the feedback).

Event-Based

In some implementations, the UE may be prohibited from performing the second UL transmission in a specific time period (e.g., before receiving the feedback (for the first UL transmission and/or for the first HARQ process) and/or if a criterion is fulfilled (e.g., based on a configuration/an IE). If the UE is prohibited from performing the second UL transmission, the UE may perform some action(s) as introduced below. The UE may receive the configuration/IE via dedicated signaling (e.g., an RRC message, an RRC reconfiguration message, an RRC release message with/without a suspend configuration) from the serving cell. The dedicated signaling carrying the configuration/IE may also include the CG configuration (for the SDT) and/or the SDT configuration.

In some implementations, for a CG-SDT procedure, when/after the UE initiates/performs the first UL transmission using the first HARQ process on the CG occasion, before receiving the feedback (for the first UL transmission and/or for the first HARQ process), the UE may not perform (any) transmission/reception, e.g., for each configured UL grant.

In one example, the transmission may be a DL reception and/or a UL transmission. In one example, the transmission may be a new transmission and/or a retransmission. In one example, the transmission may be transmitted on a PRACH, a PUSCH, a PDSCH, a PDCCH, and/or a PUCCH. In one example, the UE may determine whether to perform (any) transmission based on a configuration/an IE. The configuration/IE may indicate whether the UE can/shall perform (any) transmission in this condition. In one example, the UE may not perform any transmission that does not include CCCH data (e.g., an RRCResumeRequest message).

In some implementations, for a CG-SDT procedure, when/after the UE initiates/performs the first UL transmission using the first HARQ process on the CG occasion, before receiving the feedback (for the first UL transmission and/or for the first HARQ process), the UE may skip the transmission, e.g., for each configured UL grant.

In one example, the UE may determine whether to skip the transmission based on a configuration/an IE. The configuration/IE may indicate whether the UE can/shall skip the transmission in this condition. In one example, the UE may not perform an SSB measurement for the CG resource selection before receiving the feedback (for the first UL transmission and/or for the first HARQ process). In one example, the UE may not perform an SSB selection before receiving the feedback (for the first UL transmission and/or for the first HARQ process). In one example, the UE may not select a CG occasion before receiving the feedback (for the first UL transmission and/or for the first HARQ process). In one example, the UE may not consider that there is an available UL-SCH resource before receiving the feedback (for the first UL transmission and/or for the first HARQ process).

In some implementations, for a CG-SDT procedure, when/after the UE initiates/performs the first UL transmission using the first HARQ process on the CG occasion, before receiving the feedback (for the first UL transmission and/or for the first HARQ process), the UE may not generate a (MAC) PDU for the HARQ entity.

In one example, the UE may determine whether to generate a (MAC) PDU for the HARQ entity based on a configuration/an IE. The configuration/IE may indicate whether the UE can/shall generate a (MAC) PDU for the HARQ entity in this condition. In one example, the UE may not generate a (MAC) PDU for the second UL transmission if the HARQ process used for the second UL transmission is associated with the same HARQ process for the first UL transmission. In one example, the UE may generate a (MAC) PDU for the second UL transmission if the HARQ process used for the second UL transmission is associated with different HARQ process than the first UL transmission. As a result, the UE may generate a (MAC) PDU and store the (MAC) PDU in the buffer (e.g., associated with different HARQ process(es)) The UE may not perform a transmission of the generated (MAC) PDU on the second UL transmission. The UE may rely on the NW to schedule a dynamic UL grant for retransmitting the generated (MAC) PDU. Moreover, the NW may schedule the dynamic UL grant for retransmitting the generated (MAC) PDU after sending a feedback to the UE for the first UL transmission. In another example, the UE may perform (autonomous) retransmission for the stored (MAC) PDU, e.g., via a CG resource, after receiving the feedback (for the first UL transmission and/or for the first HARQ process).

In some implementations, for a CG-SDT procedure, when/after the UE initiates/performs the first UL transmission using the first HARQ process on the CG occasion, before receiving the feedback (for the first UL transmission and/or for the first HARQ process), the UE may consider the CG resource/UL-SCH resource is not valid/not available, e.g., for each configured UL grant.

In one example, the UE may determine whether the CG resource is valid/available based on a configuration/an IE. The configuration/IE may indicate whether the UE can/shall consider the CG resource is not valid in this condition. In one example, after receiving the feedback (for the first UL transmission and/or for the first HARQ process), the UE may re-consider the CG resource/UL-SCH resource is valid/available again.

In some implementations, when/after the UE initiates/performs the first UL transmission using the first HARQ process on the CG occasion, before receiving the feedback (for the first UL transmission and/or for the first HARQ process), the UE may not deliver the UL grant and the associated HARQ process to the HARQ entity, e.g., for each configured UL grant. In one example, the UE may determine whether to deliver the UL grant and the associated HARQ process to the HARQ entity based on a configuration/an IE. The configuration/IE may indicate whether the UE can/shall deliver the UL grant and the associated HARQ process to the HARQ entity in this condition.

In some implementations, for a CG-SDT procedure, when/after the UE initiates/performs the first UL transmission using the first HARQ process on the CG occasion, before receiving the feedback (for the first UL transmission and/or for the first HARQ process), the UE may not deliver an obtained MAC PDU to the identified HARQ process for performing a new transmission, e.g., for each configured UL grant. In one example, the UE may determine whether to deliver the obtained MAC PDU to the identified HARQ process for performing a new transmission based on a configuration/an IE. The configuration/IE may indicate whether the UE can/shall deliver the obtained MAC PDU to the identified HARQ process for performing a new transmission in this condition.

In some implementations, for a CG-SDT procedure, when/after the UE initiates/performs the first UL transmission using the first HARQ process on the CG occasion, before receiving the feedback (for the first UL transmission and/or for the first HARQ process), the UE may consider the TA is not valid.

In one example, after receiving the feedback (for the first UL transmission and/or for the first HARQ process), the UE may re-consider the TA is valid again. In one example, the UE may determine whether the TA is valid based on a configuration/an IE. The configuration/IE may indicate whether the UE can/shall consider the TA is not valid in this condition.

Timer-Based

In some implementations, the UE may be prohibited from performing the second UL transmission based on a timer (e.g., based on whether the timer is running) and/or if a criterion is fulfilled (e.g., based on a configuration/an IE). If the UE is prohibited from performing the second UL transmission, the UE may perform some action(s) as introduced below. The UE may receive the configuration/IE via dedicated signaling (e.g., an RRC message, an RRC reconfiguration message, an RRC release message with/without a suspend configuration) from the serving cell. The dedicated signaling carrying the configuration/IE may also include the CG configuration and/or the SDT configuration.

In one example, the timer may be used for monitoring the PDCCH to receive/detect the feedback (for the first UL transmission). In one example, the timer may be a timer configured in the CG configuration for the SDT. In one example, the timer may be a timer configured in the SDT configuration. In one example, the timer may be a timer configured by an RRC release (and/or a suspend configuration) message. In one example, the timer may be a timer for a CG-SDT, an SDT timer, a DRX timer (e.g., a drx inactivity timer, a drx retransmission timer), a CG timer, a CG retransmission timer, an extended T319 timer, and/or an SDT failure detection timer, etc. In one example, the timer may be a time window, e.g., a response window. In one example, the timer may be operated per MAC entity and/or per UE.

In one example, the timer may be operated individually for different HARQ processes. Specifically, when the UE performs a first UL transmission using a first HARQ process, the UE may (re-)start a first timer. When the UE performs a second UL transmission using a second HARQ process, the UE may (re-)start a second timer.

In one example, the unit of the timer may include at least one of a symbol, a slot, a subframe, ms, s, etc. In one example, the length of the timer may be configured in multiples of the periodicity of the CG.

In some implementations, for a CG-SDT procedure, when/after the UE initiates/performs the first UL transmission using the first HARQ process on the CG occasion, and if a timer is running, the UE may not perform (any) transmission, e.g., for each configured UL grant.

In one example, the transmission may be a DL and/or a UL transmission. In one example, the transmission may be a new transmission and/or a retransmission. In one example, the transmission may be transmitted on a PRACH, a PUSCH, a PDSCH, a PDCCH, and/or a PUCCH. In one example, the UE may determine whether to perform (any) transmission based on a configuration/an IE. The configuration/IE may indicate whether the UE can/shall perform (any) transmission while the timer is running. In one example, the UE may not perform (any) transmission that does not include CCCH data (e.g., an RRCResumeRequest message) if the timer is running.

In some implementations, for a CG-SDT procedure, when/after the UE initiates/performs the first UL transmission using the first HARQ process on the CG occasion and when a timer is running, the UE may skip the transmission, e.g., for each configured UL grant.

In one example, the UE may determine whether to skip the transmission based on a configuration/an IE. The configuration/IE may indicate whether the UE can/shall skip the transmission while the timer is running. In one example, the UE may not perform an SSB measurement for a CG resource selection if the timer is running. In one example, the UE may not perform an SSB selection if the timer is running. In one example, the UE may not select a CG occasion before receiving the feedback (for the first UL transmission and/or for the first HARQ process) if the timer is running. In one example, the UE may not consider there is an available UL-SCH resource before receiving the feedback (for the first UL transmission and/or for the first HARQ process) if the timer is running.

In some implementations, for a CG-SDT procedure, when/after the UE initiates/performs the first UL transmission using the first HARQ process on the CG occasion and when a timer is running, the UE may not generate a (MAC) PDU for the HARQ entity.

In one example, the UE may determine whether to generate a (MAC) PDU for the HARQ entity based on a configuration/an IE. The configuration/IE may indicate whether the UE can/shall generate a (MAC) PDU for the HARQ entity while the timer is running. In one example, the UE may not generate a (MAC) PDU for the second UL transmission while the timer is running if the HARQ process used for the second UL transmission is associated with the same HARQ process for the first UL transmission. In one example, the UE may generate a (MAC) PDU for the second UL transmission if the HARQ process used for the second UL transmission is associated with different HARQ process(es) than the first UL transmission. As a result, the UE may generate a (MAC) PDU and store the (MAC) PDU in the buffer (e.g., associated with the different HARQ process(es)). The UE may not perform a transmission of the generated (MAC) PDU on the second UL transmission while the timer is running. The UE may rely on the NW to schedule a dynamic UL grant for retransmitting the generated (MAC) PDU. Moreover, the NW may schedule the dynamic UL grant for retransmitting the generated (MAC) PDU after the timer expires (or if the timer is not running). In another example, the UE may perform a (autonomous) retransmission for the stored (MAC) PDU, e.g., via a CG resource, after the timer expires (or if the timer is not running).

In some implementations, for a CG-SDT procedure, when/after the UE initiates/performs the first UL transmission using the first HARQ process on the CG occasion and when a timer is running, the UE may consider the CG resource/UL-SCH resource is not valid/available, e.g., for each configured UL grant. In one example, the UE may determine whether the CG resource is valid/available based on a configuration/an IE. The configuration/IE may indicate whether the UE can/shall consider the CG resource being not valid while the timer is running. In one example, after the timer expires (or if the timer is not running), the UE may re-consider the CG resource/UL-SCH resource being valid/available again.

In some implementations, when/after the UE initiates/performs the first UL transmission using the first HARQ process on the CG occasion and when a timer is running, the UE may not deliver the UL grant and the associated HARQ process to the HARQ entity, e.g., for each configured UL grant. In one example, the UE may determine whether to deliver the UL grant and the associated HARQ process to the HARQ entity based on a configuration/an IE. The configuration/IE may indicate whether the UE can/shall deliver the UL grant and the associated HARQ process to the HARQ entity while the timer is running.

In some implementations, for a CG-SDT procedure, when/after the UE initiates/performs the first UL transmission using the first HARQ process on the CG occasion and if a timer is running, the UE may not deliver an obtained MAC PDU to the identified HARQ process for performing a new transmission, e.g., for each configured UL grant. In one example, the UE may determine whether to deliver the obtained MAC PDU to the identified HARQ process for performing a new transmission based on a configuration/an IE. The configuration/IE may indicate whether the UE can/shall deliver the obtained MAC PDU to the identified HARQ process for performing a new transmission while the timer is running.

In some implementations, for a CG-SDT procedure, when/after the UE initiates/performs the first UL transmission using the first HARQ process on the CG occasion and if a timer is running, the UE may consider the TA is not valid. In one example, the UE may determine whether the TA is valid based on a configuration/an IE. The configuration/IE may indicate whether the UE can/shall consider the TA is not valid while the timer is running. In one example, after the timer expires (or if the timer is not running), the UE may re-consider the TA is valid again.

NW-Based

In some implementations, the NW may configure value(s) of the configurations/IE(s) properly to avoid the transmission opportunities after transmitting the first UL transmission and before receiving the feedback. The UE may receive the configuration/IE via dedicated signaling (e.g., an RRC message, an RRC reconfiguration message, an RRC release message with/without a suspend configuration) from the serving NW. The dedicated signaling carrying the configuration/IE may also include the CG configuration and/or the SDT configuration.

In some implementations, periodicity of the CG may be configured to be longer than a length (value) of the timer.

In one example, the periodicity of the CG may be configured in the CG configuration for the SDT. Specifically, the unit of the periodicity may include at least one of a symbol, a slot, a subframe, ms, s, etc. The length of the periodicity may be configured in multiples of the length (value) of the timer.

In one example, the length (value) of the timer may be configured in the CG configuration for the SDT. Specifically, the unit of the length (value) of the timer may include at least one of a symbol, a slot, a subframe, ms, s, etc. The length (value) of the timer may be configured in multiples of the periodicity of the CG.

In one example, the timer may be used for monitoring the PDCCH to receive/detect the feedback (for the first UL transmission). In one example, the timer may be a timer configured in the CG configuration for the SDT. In one example, the timer may be a timer configured in the SDT configuration. In one example, the timer may be a timer configured by an RRC release (with/without a suspend configuration) message. In one example, the timer may be a timer for a CG-SDT, an SDT timer, a DRX timer (e.g., a drx inactivity timer, a drx retransmission timer), a CG timer, a CG retransmission timer, an extended T319 timer, and/or an SDT failure detection timer, etc. In one example, the timer may be a time window, e.g., a response window. In one example, the timer may be operated per MAC entity and/or per UE.

In one example, the timer may be operated individually for different HARQ processes. Specifically, when the UE performs a first UL transmission using a first HARQ process, the UE may (re-)start a first timer. When the UE performs a second UL transmission using a second HARQ process, the UE may (re-)start a second timer.

In some implementations, the length (value) of the timer may be configured to be longer than the length (value) of a CG retransmission timer. As such, the CG retransmission timer may expire earlier than the timer. Hence, the UE may be allowed to perform autonomous retransmission of the first UL transmission on another CG resource after the CG retransmission timer expires. Meanwhile, the UE may be prohibited from performing other transmissions because the timer is still running. Specifically, the timer is different than the CG retransmission timer.

In some implementations, the length (value) of the CG timer may be configured to be longer than a length (value) of the timer.

The Second UL Transmission is Allowed

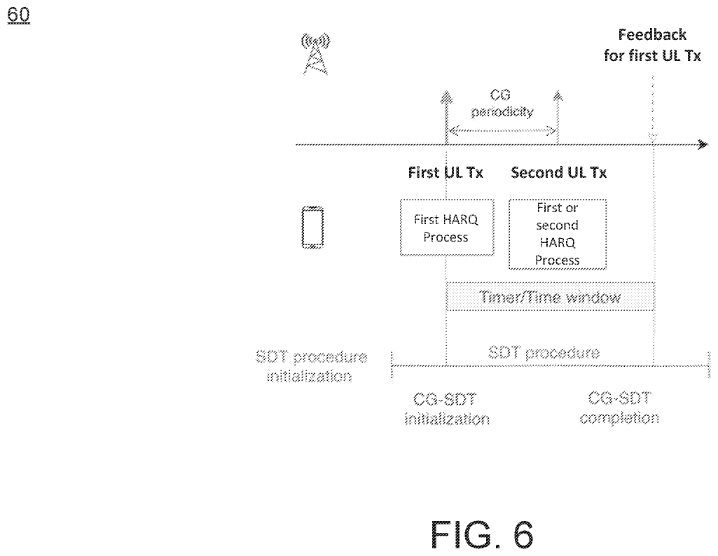

FIG. 6 illustrates a timing diagram 60 of a second UL transmission before receiving the feedback, according to an example implementation of the present disclosure. As shown in FIG. 6, the UE may be allowed to perform the second UL transmission (after transmitting the first UL transmission and/or before receiving the feedback). If the UE is allowed to perform the second UL transmission, some issues may be introduced/considered in the following:

Does the UE need to perform a beam selection again for the second UL transmission?
Which CG occasion(s) (or which SSB(s)) does the second UL transmission should be transmitted thereon?
What content should be included in the second UL transmission?
Which HARQ process should be used for the second UL transmission?
Is the second UL transmission a new transmission or a retransmission of the first UL transmission?
Does the UE need to (re-)start the timer for the second UL transmission?
Is the second UL transmission a repetition?

In some implementations, the second UL transmission may include not only a second UL transmission but also one or more of the following UL transmissions (after transmitting the first UL transmission and/or before receiving the feedback).

In some implementations, the second UL transmission may also refer to the transmissions that are performing while a timer is running.

In one example, the timer may be used for monitoring the PDCCH to receive/detect the feedback (for the first UL transmission). In one example, the timer may be a timer configured in the CG configuration for the SDT. In one example, the timer may be a timer configured in the SDT configuration. In one example, the timer may be a timer configured by an RRC release (and/or a suspend configuration) message. In one example, the timer may be a timer for a CG-SDT, an SDT timer, a DRX timer (e.g., a drx inactivity timer, a drx retransmission timer), a CG timer, a CG retransmission timer, an extended T319 timer, and/or an SDT failure detection timer, etc. In one example, the timer may be a time window, e.g., a response window. In one example, the timer may be operated per MAC entity and/or per UE.

In one example, the timer may be operated individually for different HARQ processes. Specifically, when the UE performs a first UL transmission using a first HARQ process, the UE may (re-)start a first timer. When the UE performs a second UL transmission using a second HARQ process, the UE may (re-)start a second timer.

In one example, the unit of the timer may include at least one of a symbol, a slot, a subframe, ms, and s. In one example, the length (value) of the timer may be configured in multiples of the periodicity of the CG.

CG Configuration

In some implementations, the UE may select/determine a first CG configuration for the first UL transmission, and the UE may select/determine the same CG configuration (e.g., the first CG configuration) for the second UL transmission. In one example, the UE may select/determine the same CG configuration if the UE is configured with only one CG configuration. In one example, the UE may select/determine the same CG configuration even if the UE is configured with multiple CG configurations.

In some implementations, the UE may select/determine a first CG configuration for the first UL transmission, and the UE may select/determine another different CG configuration (e.g., a second CG configuration) for the second UL transmission. In one example, the UE may select/determine the different CG configuration if the UE is configured with multiple CG configurations. The UE may re-consider the first CG configuration for a UL packet transmission after receiving HARQ ACK/NACK message of the first HARQ process associated with the first CG configuration.

Beam Selection/CG Occasion

In some implementations, the UE may select/determine a first SSB (and the corresponding CG occasion) for the first UL transmission, and the UE may select/determine the same SSB (e.g., the first SSB) (and the corresponding CG occasion) for the second UL transmission. In one example, the UE may not select/determine the SSB (and the corresponding CG occasion) again (e.g., based on an RSRP) for the second UL transmission.

In some implementations, the UE may select/determine a first SSB (and the corresponding CG occasion) for the first UL transmission, and the UE may select/determine the different SSB (e.g., a second SSB) (and the corresponding CG occasion) for the second UL transmission. In one example, the first SSB and the second SSB may have different SSB indexes. In one example, the UE may select/determine a different SSB based on the order of the SSB index. For example, if the index of the first SSB is 1, the index of the second SSB may be 2. In one example, the UE may select/determine different SSB(s) based on UE's implementation/determination.

In some implementations, the UE may select/determine a first SSB (and the corresponding CG occasion) for the first UL transmission, and the UE may select/determine a second SSB (and the corresponding CG occasion) again (e.g., based on an RSRP) for the second UL transmission, where the second SSB may be the same or different than the first SSB. In one example, the UE may select/determine the different SSB based on the same criteria used for determining the first SSB. As a result, in one aspect, the second SSB may be the same as the first SSB; in another aspect, the second SSB may be different than the first SSB.

HARQ Process

In some implementations, the UE may use a first HARQ process for the first UL transmission, and the UE may use the same HARQ process (e.g., the first HARQ process) for the second UL transmission.

In one example, the UE may transmit the same content/data (e.g., the one stored in the first HARQ process/buffer) by the second UL transmission as the content/data transmitted by the first UL transmission.

In one example, the UE may transmit the different content/data by the second UL transmission than the content/data transmitted by the first UL transmission. In one aspect, the content/data may include at least one of an RRC message (e.g., an RRC connection resume request message and/or a CCCH message), a MAC CE (e.g., a BSR, a PHR, etc.), UL data (e.g., data associated with RBs for the SDT), and padding bits.

In some implementations, the UE may use a first HARQ process for the first UL transmission, and the UE may use another different HARQ process (e.g., the second HARQ process) for the second UL transmission.

In one example, the UE may transmit the same content/data (e.g., the one stored in the first HARQ process/buffer) by the second UL transmission as the content/data transmitted by the first UL transmission. In one aspect, the UE may move/copy the content/data from the first HARQ process/buffer to the second HARQ process/buffer. In another aspect, the UE may generate the same content/data (e.g., PDU and/or SDU) of the first HARQ process/buffer to the second HARQ process/buffer.

In one example, the UE may transmit different content/data by the second UL transmission than the content/data transmitted by the first UL transmission.

In some implementations, the selection/determination of the HARQ process (ID) may be determined based on UE's implementation (e.g., the UE may select a HARQ Process ID among the HARQ process IDs available for the CG configuration for the SDT).

In some implementations, the selection/determination of the HARQ process (ID) may be based on at least one of following equations:

HARQ Process ID=[floor(CURRENT_symbol/periodicity)] modulo nrofHARQ-Processes; and

HARQ Process ID=[floor(CURRENT_symbol/periodicity)] modulo nrofHARQ-Processes+harq-ProcID-Offset2.

Where, CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to a number of consecutive slots per frame and a number of consecutive symbols per slot, respectively, as specified in TS 38.211

New Transmission/Retransmission/Repetition

In some implementations, the second UL transmission may be a new transmission. In one example, the UE may perform an LCP procedure (e.g., selecting the logical channels for the UL grant, and/or allocating the resources to the logical channels, etc.) for the second UL transmission (e.g., if the second UL transmission is a new transmission).

In some implementations, the second UL transmission may be a retransmission (of the first UL transmission).

In one example, the UE may autonomously (re)transmit the content/data of the first UL transmission by the second UL transmission. In one example, the UE may determine whether to autonomously (re)transmit the content/data of the first UL transmission by the second UL transmission based on a configuration from BS. In one aspect, if the UE is configured with the configuration, the UE may autonomously (re)transmit the content/data of the first UL transmission by the second UL transmission; in another aspect, the UE may not autonomously (re)transmit the content/data of the first UL transmission by the second UL transmission. The configuration may include a timer, e.g., a cg-RetransmissionTimer and/or an IE, e.g., an autonomous Tx.

In one example, the UE may determine whether to autonomously (re)transmit the content/data of the first UL transmission by the second UL transmission based on whether the timer is running. In one aspect, the UE may autonomously (re)transmit the content/data of the first UL transmission by the second UL transmission if the timer is running. In one aspect, the UE may autonomously (re)transmit the content/data of the first UL transmission by the second UL transmission if the timer is not running. Specifically, the timer may be a timer for a CG-SDT (e.g., a cg-SDT-retransmissiontimer), an SDT timer, a DRX timer (e.g., a drx inactivity timer, a drx retransmission timer), a CG timer, a CG retransmission timer, a new T319 timer, and/or an SDT failure detection timer, etc.

In one example, if the previous UL grant delivered to the HARQ entity for the same HARQ process was a configured UL grant for the initial transmission of the CG-SDT with a CCCH message or for its retransmission and/or if PDCCH addressed to the MAC entity's C-RNTI has not been received, the UE may determine to perform retransmission for the initial CG-SDT transmission, and/or the UE may determine the NDI bit to have not been toggled. In one example, whether the UE can/shall perform the retransmission may be based on a configuration by the BS. The UE may receive and/or store the configuration from the BS via dedicated signaling (e.g., an RRC message, an RRC reconfiguration message, an RRC release message with/without a suspend configuration). In one example, a number of retransmissions may be configured by an IE in the CG configuration for the SDT. In one example, each retransmission may be a separate UL grant delivered to the HARQ entity. In one example, the RV sequence for retransmissions may be different or may be fixed, e.g., RV={0, 2, 3, 1}. In one aspect, the first UL transmission may be associated with a first RV, and the second UL transmission may be associated with a second RV.

In one example, the second UL transmission (e.g., an autonomous retransmission of the first UL transmission) may be performed if at least one of the following conditions are satisfied:

In one aspect, the second UL transmission (e.g., an autonomous retransmission of the first UL transmission) may be performed if the UE has initiated an SDT procedure or the UE is performing an SDT procedure. The SDT procedure may be a CG-SDT procedure. In one aspect, the second UL transmission (e.g., an autonomous retransmission of the first UL transmission) may be performed if the first UL transmission includes a CCCH message (e.g., an RRC resume request message). In one aspect, the second UL transmission (e.g., an autonomous retransmission of the first UL transmission) may be performed if the first UL transmission is an initial UL transmission after initiating a CG-SDT procedure. In one aspect, the second UL transmission (e.g., an autonomous retransmission of the first UL transmission) may be performed if the first UL transmission is transmitted via a CG resource. For example, the MAC entity may deliver the configured UL grant and the associated HARQ information to the HARQ entity. In one aspect, the second UL transmission (e.g., an autonomous retransmission of the first UL transmission) may be performed if a specific timer expires or is not running. The specific timer may be a CG retransmission timer or a CG timer. In one aspect, the second UL transmission (e.g., an autonomous retransmission of the first UL transmission) may be performed if the UE is in the RRC_INACTIVE state. In one aspect, the second UL transmission (e.g., an autonomous retransmission of the first UL transmission) may be performed if a timer is running.

In one aspect, the timer may be used for monitoring the PDCCH to receive/detect the feedback (for the first UL transmission). In one aspect, the timer may be a timer configured in the CG configuration for the SDT. In one aspect, the timer may be a timer configured in the SDT configuration. In one aspect, the timer may be a timer configured by an RRC release (and/or a suspend configuration) message. In one aspect, the timer may be a timer for a CG-SDT, an SDT timer, a DRX timer (e.g., a drx inactivity timer, a drx retransmission timer), a CG timer, a CG retransmission timer, an extended T319 timer, and/or an SDT failure detection timer, etc. In one aspect, the timer may be a time window, e.g., a response window. In one aspect, the timer may be operated per MAC entity and/or per UE.

In one aspect, the timer may be operated individually for different HARQ processes. Specifically, when the UE performs a first UL transmission using a first HARQ process, the UE may (re-)start a first timer. When the UE performs a second UL transmission using a second HARQ process, the UE may (re-)start a second timer.

In one aspect, the unit of the timer may include at least one of a symbol, a slot, a subframe, ms, s, etc. In one aspect, the length of the timer may be configured in multiples of the periodicity of the CG.

In some implementations, the second UL transmission may be a repetition transmission (of the first UL transmission).

In one example, the UE may perform a (HARQ) retransmissions (e.g., the second UL transmission) that is triggered without waiting for a feedback from a previous transmission (e.g., the first UL transmission) within a bundle. In one example, each repetition within a bundle may be a separate UL grant delivered to the HARQ entity. In one example, for each transmission within a bundle of the configured UL grant, the sequence of RVs may be determined based on standards specified in TS 38.214. In one example, whether the UE can/shall perform the repetition may be based on a configuration by the BS. The UE may receive and/or store the configuration from the BS via dedicated signaling (e.g., an RRC message, an RRC reconfiguration message, an RRC release message with/without a suspend configuration). In one example, a number of repetitions may be configured by an IE (e.g., repK) in the CG configuration for the SDT. In one example, the repetitions may be considered as a bundle of transmission occasions that are mapped to the same SSB(s). In one example, if the repetition is supported for a CG-SDT, all repetitions within a period may be regarded as a bundle, e.g., all PUSCH repetitions are associated with the same SSB(s). In one example, the RV sequence for the repetitions may be different or may be fixed, e.g., RV={0, 2, 3, 1}.

In some implementations, the UE may toggle the NDI in the CG-UCI for new transmissions and may not toggle the NDI in the CG-UCI in retransmissions. In one example, the UE may transmit the CG-UCI via the first UL transmission and/or the second UL transmission.

Timer

In some implementations, when/after the UE initiates/performs the first UL transmission (e.g., based a configured UL grant), the UE may start a first timer. When/after the UE initiates/performs the second UL transmission (e.g., based a specific UL grant), the UE may start a second timer.

In some implementations, when/after the UE initiates/performs the first UL transmission (e.g., based a configured UL grant), the UE may start a first timer. When/after the UE initiates/performs the second UL transmission (e.g., based a specific UL grant), the UE may or may not stop the first timer.

In some implementations, when/after the UE initiates/performs the first UL transmission (e.g., based a configured UL grant), the UE may start a first timer. When/after the UE initiates/performs the second UL transmission (e.g., based a specific UL grant), the UE may (re-)start the first timer.

In some implementations, the UE may monitor a PDCCH addressed to a specific RNTI (e.g., a C-RNTI, a CS-RNTI, an SDT-RNTI, a cg-SDT-RNTI, etc.) on a specific SS (e.g., a SS configured in the CG configuration for the SDT) when either one of the first timer and the second timer is running.

In some implementations, the first timer and/or the second timer may be a timer for a CG-SDT (e.g., a CG-SDT retransmission timer), an SDT timer, a DRX timer (e.g., a drx inactivity timer, a drx retransmission timer), a CG timer, a CG retransmission timer, an extended T319 timer, and/or an SDT failure detection timer, etc.

In some implementations, the UE performing a UL transmission may include that the MAC entity/UE delivers the UL grant and the associated HARQ information to the HARQ entity.

The Feedback for the First UL Transmission is not Received

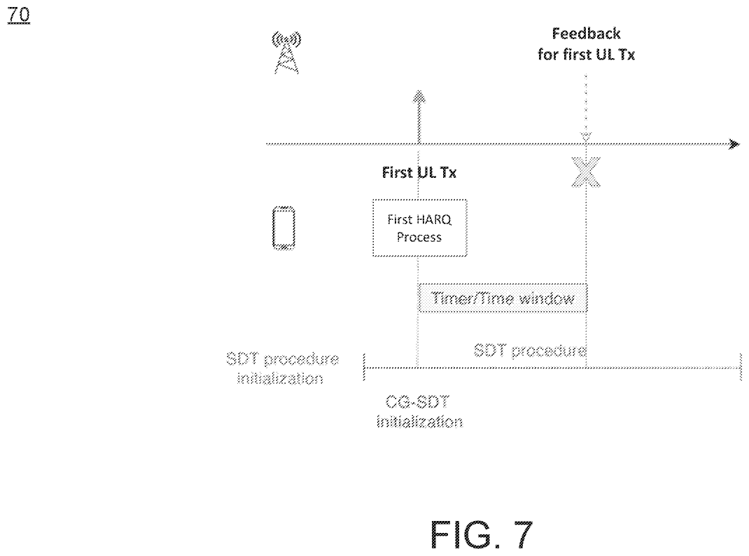

FIG. 7 illustrates a timing diagram of a feedback reception failure 70, according to an example implementation of the present disclosure. As shown in FIG. 7, when/after the UE initiates an SDT procedure (and/or selects a UL carrier for the SDT procedure), the UE may determine to initiate/trigger a CG-SDT procedure (e.g., if at least one of the SSBs with an SS-RSRP above a cg-SDT-RSRP-ThresholdSSB is available).

In some implementations, when/after the UE initiates/triggers a CG-SDT procedure, the UE may perform at least one of the following actions/operations:

select/determine an SSB (e.g., an SSB with an SS-RSRP above a cg-SDT-RSRP-ThresholdSSB);
select/determine a CG configuration (e.g., a CG type 1 configuration on a BWP of the selected UL carrier associated with the selected SSB);
select/determine a CG occasion (e.g., corresponding to the selected SSB and the selected CG configuration); and
select/determine a first HARQ process for the CG occasion.

In one example, the CG occasion may be a PUSCH resource occasion.

In some implementations, when/after the UE selects/determines the SSB, the CG configuration, the CG occasion, and/or the first HARQ process, the UE may initiate/perform a first UL transmission using the first HARQ process on the CG occasion (during the CG-SDT procedure and/or the SDT procedure). In one example, the first UL transmission may be a first UL transmission after initiating the SDT procedure and/or after initiating the CG-SDT procedure. In one example, the first UL transmission may include an RRC message (e.g., an RRC connection resume request message and/or a CCCH message), a MAC CE (e.g., a BSR, a PHR, etc.), a UL data (e.g., data associated with RBs for the SDT), and/or padding bits, etc. In one example, the first UL transmission may be an initial/new transmission.

In some implementations, when/after the UE initiates/performs the first UL transmission using the first HARQ process on the CG occasion, the UE may (re-)start a timer (for the HARQ process). While the timer is running, the UE may monitor a PDCCH addressed to a specific RNTI (e.g., a C-RNTI, a CS-RNTI, an SDT-RNTI, a cg-SDT-RNTI, etc.) on a specific SS (e.g., a SS configured in the CG configuration for the SDT).

In one example, the timer may be a timer configured in the CG configuration for the SDT. In one example, the timer may be a timer for a CG-SDT, a DRX timer (e.g., a drx inactivity timer, a drx retransmission timer), a CG timer, a CG retransmission timer, a new T319 timer, and/or an SDT failure detection timer, etc. In one example, the timer may be a time window, e.g., a response window.

In one example, the timer may be operated individually for different HARQ processes. In one aspect, when the UE performs a first UL transmission using a first HARQ process, the UE may (re-)start a first timer. In another aspect, when the UE performs a second UL transmission using a second HARQ process, the UE may (re-)start a second timer.

In some implementations, when/after the UE monitors the PDCCH while the timer is running, the UE may attempt to receive/detect a feedback (for the first UL transmission and/or for the first HARQ process) from the BS.

In one example, the feedback may be a DL indication transmitted by the BS on the PDCCH, e.g., via a specific DCI, addressed to the specific RNTI (e.g., a C-RNTI, a CS-RNTI, an SDT-RNTI, a cg-SDT-RNTI, etc.). In one example, the feedback may be a DL indication transmitted by the BS on the PDSCH, e.g., via a specific MAC CE and/or an RRC message. In one example, the feedback may indicate a UL grant for a new transmission on the same HARQ process used for the first UL transmission (e.g., the first HARQ process). If the feedback indicates a UL grant for a new transmission on the same HARQ process used for the first UL transmission, the UE may consider it as an ACK. In one example, the feedback may indicate an ACK/NACK information (for the first UL transmission and/or for the first HARQ process). In one example, the feedback may indicate a DFI (for the first UL transmission and/or for the first HARQ process).

As shown in FIG. 7, it is possible that the UE may fail to receive the feedback (for the first UL transmission and/or for the first HARQ process). Specifically, the UE may monitor the PDCCH, while the timer is running, to attempt receiving/detecting a feedback (for the first UL transmission and/or for the first HARQ process) from the BS. The UE may not receive any feedback until the timer expires or the UE may receive a NACK information from the BS. As a result, the UE may consider the first UL transmission is not successful. Thus, the UE may perform some actions for failure handling, and some proposed implementations may be applied by the UE to handle the failure, e.g., when the UE does not receive the feedback for the first UL transmission, when the UE does not receive any feedback (for the first UL transmission) until the timer expires, or when the UE receives a feedback including a NACK information (before the timer expires).

Second UL Transmission if Feedback Reception Failure

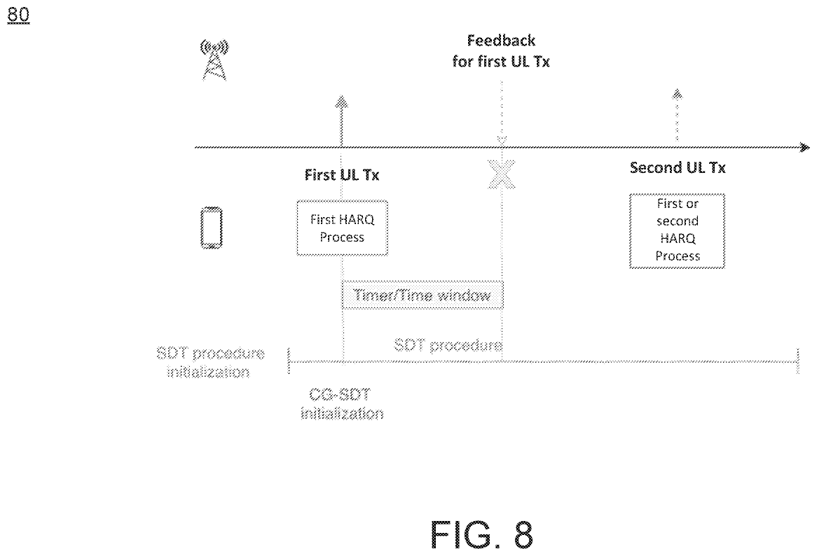

FIG. 8 illustrates a timing diagram of a second UL transmission 80 after the timer expires, according to an example implementation of the present disclosure. In some implementations, as shown in FIG. 8, when/after the UE initiates/performs the first UL transmission using the first HARQ process on the CG occasion, the UE may (re-)start a timer. The UE may monitor the PDCCH, while the timer is running, to attempt to receive/detect a feedback (for the first UL transmission and/or for the first HARQ process) from the BS. If the timer expires (and/or the UE does not receive any feedback), or if the timer expires (and/or the UE does not receive the feedback for the first UL transmission) or if the UE receives a NACK information (before the timer expires), the UE may perform a second UL transmission (e.g., a retransmission) for the first UL transmission. In some implementations, the timer expires may include the following scenarios/cases/examples that the timer is not running.

In one example, the second UL transmission may be a retransmission (of the first UL transmission). In one example, the second UL transmission may be performed after transmitting the first UL transmission. In one example, the second UL transmission may be performed after the timer expires. In one example, the second UL transmission may be transmitted via a CG (that is configured by a CG configuration for the SDT) and/or a DG (that is scheduled by the BS). In one example, the UE may determine whether to perform the second UL transmission based on a configuration/an IE. The configuration/IE may indicate whether the UE can/shall perform the second UL transmission, e.g., if the timer expires (and/or the UE does not receive any feedback), or if the timer expires (and/or the UE does not receive the feedback for the first UL transmission) or if the UE receives a NACK information (before the timer expires). The UE may receive and/or store the configuration from the BS via dedicated signaling (e.g., an RRC message, an RRC reconfiguration message, an RRC release message with/without a suspend configuration).

In some implementations, the second UL transmission may include a second UL transmission and one or more of the following UL transmissions (if the timer expires (and/or the UE does not receive any feedback), or if the timer expires (and/or the UE does not receive the feedback for the first UL transmission) or if the UE receives a NACK information (before the timer expires).

Retransmission

In some implementations, the second UL transmission may be a retransmission (of the first UL transmission).

In one example, the UE may autonomously retransmit the content/data of the first UL transmission by the second UL transmission. The second UL transmission may be transmitted via a CG resource after the first UL transmission.

In one example, the UE may determine whether to autonomously retransmit the content/data of the first UL transmission by the second UL transmission based on a configuration from the BS. In one aspect, if the UE is configured with the configuration, the UE may autonomously retransmit the content/data of the first UL transmission by the second UL transmission; in another aspect, the UE may not autonomously retransmit the content/data of the first UL transmission by the second UL transmission. The configuration may include a timer, e.g., a cg-RetransmissionTimer and/or an IE, e.g., an autonomousTx. The UE may receive and/or store the configuration from the BS via dedicated signaling (e.g., an RRC message, an RRC reconfiguration message, an RRC release message with/without a suspend configuration).

In one example, the UE may determine whether to autonomously retransmit the content/data of the first UL transmission by the second UL transmission based on whether the timer is running. In one aspect, the timer may be a timer for a CG-SDT, an SDT timer, a DRX timer (e.g., a drx inactivity timer, a drx retransmission timer), a CG timer, a CG retransmission timer, a new T319 timer, and/or an SDT failure detection timer, etc.

In one example, whether the UE can/shall perform the retransmission may be based on a configuration by the BS. The UE may receive and/or store the configuration from the BS via dedicated signaling (e.g., an RRC message, an RRC reconfiguration message, an RRC release message with/without a suspend configuration).

In one example, a number of retransmissions may be configured by an IE in the CG configuration for the SDT.

In one example, each retransmission may be a separate UL grant delivered to the HARQ entity.

In one example, the RV sequence for retransmissions may be different or may be fixed, e.g., RV={0, 2, 3, 1}. In one aspect, the first UL transmission may be associated with a first RV, and the second UL transmission may be associated with a second RV.

In one example, the second UL transmission (e.g., an autonomous retransmission of the first UL transmission) may be performed if one or more of the following conditions are satisfied.

In one condition, the second UL transmission (e.g., an autonomous retransmission of the first UL transmission) may be performed if the UE has initiated an SDT procedure or the UE is performing an SDT procedure. Specifically, the SDT procedure may be a CG-SDT procedure. In one condition, the second UL transmission (e.g., an autonomous retransmission of the first UL transmission) may be performed if the first UL transmission includes a CCCH message (e.g., an RRC resume request message). In one condition, the second UL transmission (e.g., an autonomous retransmission of the first UL transmission) may be performed if the first UL transmission is an initial UL transmission after initiating a CG-SDT procedure. In one condition, the second UL transmission (e.g., an autonomous retransmission of the first UL transmission) may be performed if the first UL transmission is transmitted via a CG resource. For example, the MAC entity delivering the UL grant to the corresponding HARQ entity is a CG. In one condition, the second UL transmission (e.g., an autonomous retransmission of the first UL transmission) may be performed if a specific timer expires or is not running. The specific timer may be a CG retransmission timer and/or a CG timer. In one condition, the second UL transmission (e.g., an autonomous retransmission of the first UL transmission) may be performed if the UE is in the RRC_INACTIVE state. In one condition, the second UL transmission may correspond to the same HARQ process as the first UL transmission does. In one condition, the second UL transmission may correspond to the same CG configuration as the first UL transmission does. In one condition, the PUSCH for the second UL transmission may be located on the same BWP as the PUSCH for the first UL transmission is.

In some implementations, the UE may not toggle the NDI in the CG-UCI for retransmissions. In one example, the UE may transmit the CG-UCI via the first UL transmission and/or the second UL transmission.

CG Configuration

In some implementations, the UE may select/determine a first CG configuration for the first UL transmission, and the UE may select/determine the same CG configuration (e.g., the first CG configuration) for the second UL transmission. In one example, the UE may select/determine the same CG configuration if the UE is configured with only one CG configuration. In one example, the UE may select/determine the same CG configuration even if the UE is configured with multiple CG configurations.

In some implementations, the UE may select/determine a first CG configuration for the first UL transmission, and the UE may select/determine another different CG configuration (e.g., a second CG configuration) for the second UL transmission. In one example, the UE may select/determine another different CG configuration if the UE is configured with multiple CG configurations.

Beam Selection/CG Occasion

In some implementations, the UE may select/determine a first SSB (and the corresponding CG occasion) for the first UL transmission, and the UE may select/determine the same SSB (e.g., the first SSB) (and the corresponding CG occasion) for the second UL transmission. In one example, the UE may not select/determine the SSB (and the corresponding CG occasion) again (e.g., based on an RSRP) for the second UL transmission.

In some implementations, the UE may select/determine a first SSB (and the corresponding CG occasion) for the first UL transmission, and the UE may select/determine another different SSB (e.g., a second SSB) (and the corresponding CG occasion) for the second UL transmission. In one example, the first SSB and the second SSB may have different SSB indexes. In one example, the UE may select/determine another different SSB based on the order of the SSB index. For example, if the index of the first SSB is 1, the index of the second SSB may be 2. In one example, the UE may select/determine another different SSB based on implementation of the UE.

In some implementations, the UE may select/determine a first SSB (and the corresponding CG occasion) for the first UL transmission, and the UE may select/determine a second SSB (and the corresponding CG occasion) again (e.g., based on an RSRP) for the second UL transmission. Specifically, the second SSB may be the same with the first SSB; or the second SSB may be different from the first SSB. In one example, the UE may select/determine the second SSB based on the same criteria used for determining the first SSB. As a result, the second SSB may be the same as the first SSB; or the second SSB may be different from the first SSB.

HARQ Process

In some implementations, the UE may use a first HARQ process for the first UL transmission, and the UE may use the same HARQ process (e.g., the first HARQ process) for the second UL transmission.

In one example, the UE may transmit the same content/data (e.g., the one stored in the first HARQ process/buffer) by the second UL transmission as the content/data transmitted by the first UL transmission. In one aspect, the content/data may include one or more of an RRC message (e.g., an RRC connection resume request message and/or a CCCH message), a MAC CE (e.g., a BSR, a PHR, etc.), UL data (e.g., data associated with RBs for the SDT), and/or padding bits, etc.

In some implementations, the UE may use a first HARQ process for the first UL transmission, and the UE may use another different HARQ process (e.g., the second HARQ process) for the second UL transmission.

In one example, the UE may transmit the same content/data (e.g., the one stored in the first HARQ process/buffer) by the second UL transmission as the content/data transmitted by the first UL transmission. In one aspect, the UE may move/copy the content/data from the first HARQ process/buffer to the second HARQ process/buffer. In another aspect, the UE may generate the same content/data (e.g., a PDU and/or an SDU) from the first HARQ process/buffer to the second HARQ process/buffer. In one example, the UE may transmit on the second UL transmission with a different HARQ process only if the first UL transmission and the second UL transmission correspond to the same CG configuration. In one example, the UE may transmit on the second UL transmission with a different HARQ process only if the first UL transmission and the second UL transmission have the same TBS.

In some implementations, the selection/determination of the HARQ process (ID) may be up to implementation of the UE (e.g., the UE may select an HARQ Process ID among the HARQ process IDs that is available for the CG configuration for the SDT). In some implementations, the selection/determination of the HARQ process (ID) may be based on at least one of the following equations:

HARQ Process ID=[floor(CURRENT_symbol/periodicity)] modulo nrofHARQ-Processes; and

HARQ Process ID=[floor(CURRENT_symbol/periodicity)] modulo nrofHARQ-Processes+harq-ProcID-Offset2.

Where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to a number of consecutive slots per frame and a number of consecutive symbols per slot, respectively, as specified in TS 38.211

Inter-Layer Indication

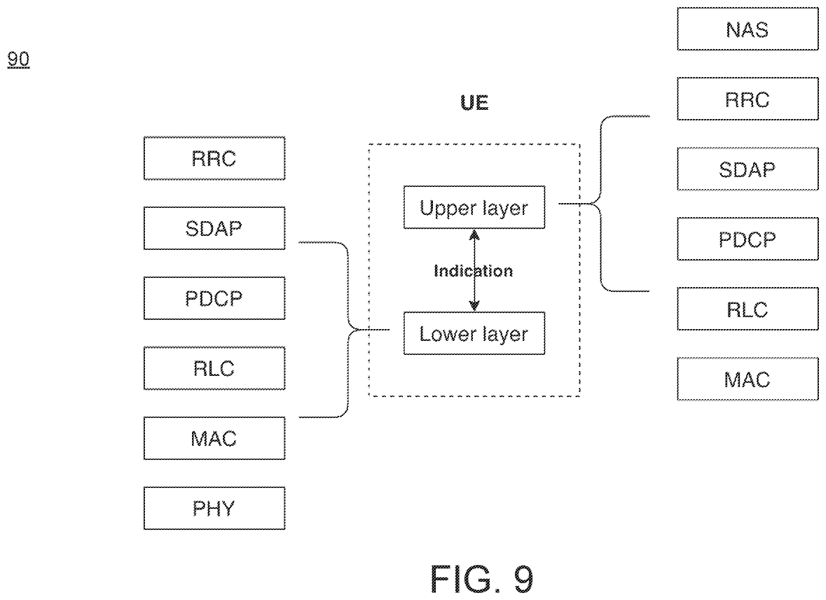

FIG. 9 illustrates a diagram of an internal-layer indication 90, according to an example implementation of the present disclosure. As shown in FIG. 9, the upper layer of the UE may be referred to at least one the following layers/entities, e.g., NAS, RRC, SDAP, PDCP, RLC, and MAC. The lower layer of the UE may be referred to at least one of the following layers/entities, e.g., RRC, SDAP, PDCP, RLC, MAC, and PHY.

In some implementations, an SDT procedure may be initiated/controlled by an upper layer (e.g., an RRC layer). While the SDT procedure is performing/ongoing, the functions of the SDT procedure may be performed by a lower layer (e.g., the MAC layer). Since the SDT procedure may be handled by different layers of the UE, the inter-layer communication is needed.

In some implementations, the lower layer of the UE may indicate an inter-layer indication to the upper layer of the UE (e.g., the RRC layer), e.g., based on some criteria. The inter-layer indication may be a kind of indication specifically for the SDT, the CG-SDT, and/or the RA-SDT.

In one example, the lower layer of the UE (e.g., the MAC layer) may indicate that an SDT initiation is unsuccessful (e.g., the conditions for initiating the SDT are not fulfilled) to the upper layer of the UE (e.g., the RRC layer), e.g., based on some criteria. In one example, the lower layer of the UE (e.g., the MAC layer) may indicate that an SDT initiation is successful (e.g., the conditions for initiating the SDT are fulfilled) to the upper layer of the UE (e.g., the RRC layer), e.g., based on some criteria.

In some implementations, when/after the UE monitors the PDCCH while the timer is running, the UE (e.g., the MAC entity of the UE) may attempt to receive/detect a feedback (for the first UL transmission and/or for the first HARQ process) from the BS.

In one example, the feedback may be a DL indication transmitted by the BS on the PDCCH, e.g., via a specific DCI, addressed to the specific RNTI (e.g., a C-RNTI, a CS-RNTI, an SDT-RNTI, a cg-SDT-RNTI, etc.). In one example, the feedback may be a DL indication transmitted by the BS on the PDSCH, e.g., via a specific MAC CE and/or an RRC message. In one example, the feedback may indicate a UL grant for a new transmission on the same HARQ process used for the first UL transmission (e.g., the first HARQ process). If the feedback indicates a UL grant for a new transmission on the same HARQ process used for the first UL transmission, the UE may consider it as an ACK. In one example, the feedback may indicate an ACK/NACK information (for the first UL transmission and/or for the first HARQ process). In one example, the feedback may indicate a DFI (for the first UL transmission and/or for the first HARQ process).

In some implementations, if the timer expires (and/or the UE does not receive any feedback), the lower layer of the UE (e.g., the MAC layer) may indicate that a (CG-)SDT initiation is failed/unsuccessful (e.g., the conditions for initiating the SDT are not fulfilled) to the upper layer of the UE (e.g., the RRC layer). Therefore, the timer may be configured/managed/set/stopped/released by the MAC layer (or a MAC entity). As a result, the timer may be released/stopped with reset of the MAC while the reset of the MAC is performed (e.g., based on the instruction of the RRC layer/RRC entity of the UE) during the SDT procedure.

In some implementations, if the UE receives a NACK information (for the first UL transmission and/or for the first HARQ process), the lower layer of the UE (e.g., the MAC layer) may indicate that a (CG-)SDT initiation is failed/unsuccessful (e.g., the conditions for initiating the (CG-)SDT are not fulfilled) to the upper layer of the UE (e.g., the RRC layer).

In some implementations, if the UE receives the feedback (for the first UL transmission and/or for the first HARQ process), the lower layer of the UE (e.g., the MAC layer) may indicate that a (CG-)SDT initiation is successful (e.g., the conditions for initiating the SDT are fulfilled) to the upper layer of the UE (e.g., the RRC layer).

In some implementations, if the UE receives ACK information (for the first UL transmission and/or for the first HARQ process), the lower layer of the UE (e.g., the MAC layer) may indicate that a (CG-)SDT initiation is successful (e.g., the conditions for initiating the (CG-)SDT are fulfilled) to the upper layer of the UE (e.g., the RRC layer).

Fallback

In some implementations, if the timer expires (and/or the UE does not receive any feedback upon the timer expires) or if the UE receives NACK information (for the first UL transmission and/or for the first HARQ process), the UE may perform at least one of the following actions/operations:

stop the SDT procedure;
stop the CG-SDT procedure;
release/suspend a CG configuration (to which the timer corresponds);
initiate a new SDT procedure;
initiate a new CG-SDT procedure (e.g., initiate a new SDT with a CG type 1 on the selected UL carrier);
initiate a RA-SDT procedure (e.g., initiate an RA procedure on the selected UL carrier for the SDT);
initiate a normal RA procedure (e.g., initiate an RA procedure for a CCCH logical channel (e.g., not for the SDT);
initiate an RRC establishment procedure, e.g., via an RRCSetupRequest;
initiate an RRC reestablishment procedure, e.g., via an RRCRestablishmentRequest;
initiate an RRC connection resume procedure, e.g., via an RRCResumeRequest;
initiate a cell (re-)selection procedure;
enter into the RRC_IDLE state;
stay in the RRC_INACTIVE state; and
increment a value of the counter by 1.

In one example, the counter may be a transmission counter for the SDT. Specifically, the counter may be used to count a number of a UL (re)transmission (during the SDT procedure, e.g., the CG-SDT and/or the RA-SDT).

In one example, the counter may be a failure counter for the SDT. Specifically, the counter may be used to count a number of a failure instance.

In one example, the counter may be a PREAMBLE_TRANSMISSION_COUNTER, a PREAMBLE_POWER_RAMPING_COUNTER, a BFI_COUNTER, an RETX_COUNT, an SDT indication/instance COUNTER.

In one example, a maximum value for the counter may be configured for the SDT. The maximum value for the counter may be configured via an RRC release message. The maximum value for the counter may be configured via an RRC release message with a suspend configuration. The maximum value for the counter may be configured via a configuration for the SDT. The maximum value for the counter may be configured via an RACH configuration for the SDT. The maximum value for the counter may be configured via a CG configuration for the SDT. The maximum value for the counter may be configured via SI (e.g., an SIB). The maximum value for the counter may be an SDTFailureInstanceMaxCounter, a preambleTransMax, a msgA-TransMax, a beamFailureInstanceMaxCount, a maxRetxThreshold, an N310, an N311, and/or a new Nx.

In one example, the counter may be configured in the MAC entity. The counter may be reset/stopped upon reset of the MAC being performed during/after/when the SDT procedure finishes/fails. In one aspect, the counter may be configured in the RRC layer and the counter may be stopped/released upon the SDT procedure finishing/failing.

In some implementations, if the value of the counter reaches the maximum value, the UE may perform at least one of the following actions/operations:

stop the SDT procedure;
stop the CG-SDT procedure;
release/suspend a CG configuration (to which the timer corresponds);
initiate a new SDT procedure;
initiate a new CG-SDT procedure (e.g., initiate a new SDT with a CG type 1 on the selected UL carrier);
initiate a RA-SDT procedure (e.g., initiate an RA procedure on the selected UL carrier for the SDT);
initiate a normal RA procedure (e.g., initiate an RA procedure for a CCCH logical channel (e.g., the one not for the SDT);
initiate an RRC establishment procedure, e.g., via an RRCSetupRequest;
initiate an RRC reestablishment procedure, e.g., via an RRCRestablishmentRequest;
initiate an RRC connection resume procedure, e.g., via an RRCResumeRequest;
initiate a cell (re-)selection procedure;
enter into the RRC_IDLE state;
stay in the RRC_INACTIVE state;
the maximum value of the counter (e.g., a threshold value) may be pre-configured by the serving RAN as part of the SDT configuration; and
reset/release the counter.

In some implementations, the value of the counter may be reset/set to 0/set to 1 under the following scenarios/conditions/examples being fulfilled/satisfied.

In one example, the value of the counter may be reset/set to 0/set to 1 when the UE receives an RRC release message (with a suspend configuration). The RRC release message may include a configuration(s) for the SDT. In one example, the value of the counter may be reset/set to 0/set to 1 when the (RA-based and/or CG-based) SDT procedure is initiated. In one example, the value of the counter may be reset/set to 0/set to 1 when the (RA-based and/or CG-based) SDT procedure is terminated/stopped/completed/aborted. In one example, the value of the counter may be reset/set to 0/set to 1 when the RA procedure is initiated. The value of the counter may be reset/set to 0/set to 1 when the RA procedure is terminated/stopped/completed/aborted. In one example, the value of the counter may be reset/set to 0/set to 1 when a CG configuration is (re-)initialized. The value of the counter may be reset/set to 0/set to 1 when the CG configuration is released/suspended/cleared.

In one example, the value of the counter may be reset/set to 0/set to 1 when the UE (successfully or unsuccessfully) transmits or retransmits a UL message. In one aspect, the UL message may be transmitted via MSG1/MSG3/MSGA/CG resource/a UL resource scheduled by MSG2/MSGB/MSG4 (during the SDT procedure). In one aspect, the UL message may include an RRC resume request message (e.g., an RRCResumeRequest or an RRCResumeRequest1). In one aspect, the UL message may include small data (e.g., UL data associated with a specific SRB/DRB/LCH that is configured/enabled for the SDT). In one aspect, the UL message may include a MAC CE (e.g., a BSR MAC CE). In one aspect, if the UL message is (re-)transmitted based on a CG resource/configuration, the timer/window that corresponds to the CG configuration may be (re-)started. In one aspect, if the UL message is transmitted on a UL resource scheduled by a dynamic grant and the dynamic grant is used for retransmission of a HARQ process that is used for transmitting UL data via a CG resource, the timer/window that corresponds to the CG configuration may be (re-)started. In one aspect, the UE may determine whether the transmission of the UL message is successful or unsuccessful based on whether a response (e.g., an ACK/NACK) is received.

In one example, the value of the counter may be reset/set to 0/set to 1 when the UE receives a response from the NW. In one aspect, the response may be an MSG2/MSG4/MSGB and/or a response for a UL transmission via the CG resource. In one aspect, the response may be used for the contention resolution, e.g., for an RA procedure. In one aspect, the response may include an (HARQ) ACK/NACK, e.g., for a UL transmission via the CG resource. In one aspect, the response may contain a UL grant/DL assignment for a new transmission/retransmission. The response may be a PDCCH addressed to an RNTI (e.g., a C-RNTI, a CS-RNTI, a dedicated RNTI, an RNTI for the SDT, and/or an RNTI for the CG). In one aspect, the response may indicate a UL grant for a new transmission for the HARQ process that is used for a UL transmission for small data (e.g., the UL message). In one aspect, the response may include a specific command, e.g., a TA command MAC CE. In one aspect, the response may be an RRCResume, an RRCSetup, an RRCRelease, an RRCRelease with a SuspendConfig, an RRCReestablishment, and/or an RRCReject, etc.

In one example, the value of the counter may be reset/set to 0/set to 1 when the UE receives a PDCCH, e.g., addressed to an RNTI (e.g., a C-RNTI, a CS-RNTI, a dedicated RNTI, an RNTI for the SDT, and/or an RNTI for the CG). In one example, the value of the counter may be reset/set to 0/set to 1 when receiving a DL transmission, e.g., on a PDSCH. In one example, The value of the counter may be reset/set to 0/set to 1 when a timer/window (as mentioned from the above) expires. In one example, the timer/window may be (re)started when the counter is incremented by 1. In another example, the timer/window may be (re)started when the counter reaches to a maximum value (e.g., based on a configured threshold).

UE Behaviors of The Timer

In some implementations, some operations/explanations/descriptions of any one of the above timers are introduced with more details.

(Re-)Start The Timer

In one example, the timer may be (re-)started when the UE receives an RRC release message (with a suspend configuration). The RRC release message may include a configuration(s) for the SDT. In one example, the timer may be (re-)started when the SDT procedure is initiated. In one example, the timer may be (re-)started when the RA procedure is initiated. In one example, the timer (for one or multiple or all CG configuration(s)) may be (re-)started when a CG configuration (that corresponds to the timer) is initialized. In one example, the timer may be (re-)started when the subsequent transmission period is started.

In one example, the timer may be (re-)started when the UE transmits or retransmits a UL message. In one aspect, the UL message may be transmitted via the MSG1/MSG3/MSGA/CG resource/a UL resource scheduled by the MSG2/MSGB/MSG4 (during the SDT procedure). In one aspect, the UL message may include an RRC resume request message (e.g., an RRCResumeRequest or an RRCResumeRequest1). In one aspect, the UL message may include small data (e.g., UL data associated with a specific SRB/DRB/LCH for the SDT). In one aspect, the UL message may include a MAC CE (e.g., a BSR MAC CE). In one aspect, if the UL message is (re-)transmitted based on a CG resource/configuration, the timer that corresponds to the CG configuration may be (re-)started. In one aspect, if the UL message is transmitted on a UL resource scheduled by a dynamic grant and the dynamic grant is used for retransmission of a HARQ process that is used for transmitting a UL data via the CG resource, the timer that corresponds to the CG configuration may be (re-)started.

In one example, the timer may be (re-)started when the UE receives a response from the NW. In one aspect, the response may be a MSG2/MSG4/MSGB and/or a response for a UL transmission via the CG resource. In one aspect, the response may be used for the contention resolution, e.g., for an RA procedure. In one aspect, the response may include an ACK/NACK, e.g., for a UL transmission via the CG resource. As a result, the timer corresponds to the CG configuration of the CG resource may be (re-)started. In one aspect, the response may contain a UL grant/DL assignment for a new transmission/retransmission. The response may be a PDCCH addressed to an RNTI (e.g., a C-RNTI, a CS-RNTI, a dedicated RNTI, an RNTI for the SDT, and/or an RNTI for the CG). As a result, if the UL grant/DL assignment is used for indicating a retransmission of a HARQ process that is used for transmitting UL data via the CG resource, the timer that corresponds to the CG configuration may be (re-)started. In one aspect, the response may indicate a UL grant for a new transmission for the HARQ process used for the transmission of a UL transmission for small data (e.g., the UL message). In one aspect, the response may include a specific command, e.g., a TA command MAC CE. In one aspect, the response may be an RRCResume, an RRCSetup, an RRCRelease, an RRCRelease with an SuspendConfig, an RRCReestablishment, and/or an RRCReject message, etc.

In one example, the timer may be (re-)started when the UE receives a PDCCH, e.g., addressed to an RNTI (e.g., a C-RNTI, a CS-RNTI, a dedicated RNTI, an RNTI for the SDT, and/or an RNTI for the CG). The timer/window may be (re-)started when the UE receives a DL assignment, e.g., on a PDCCH and/or a DL message/data, e.g., on a PDSCH.

In one example, the timer may be (re-)started when another timer (e.g., a HARQ RTT timer) expires. The another timer (e.g., a HARQ RTT timer) may indicate a minimum duration before a DL assignment and/or UL HARQ retransmission grant is expected by the UE/MAC entity.

In one example, the timer may be delayed to be (re-)started after a configured offset. The configured offset may indicate a minimum duration before a DL assignment and/or a UL HARQ retransmission grant is expected by the UE/MAC entity. The configured offset may also be configured per CG configuration.

Stop The Timer

In one example, the timer may be stopped when the SDT procedure is terminated. In one example, the timer may be stopped when the RA procedure is stopped/aborted. In one example, the timer (for one or multiple or all CG configuration(s)) may be stopped when the corresponding CG configuration is released/suspended/cleared. In one example, the timer (for one or multiple or all CG configuration(s)) may be stopped when the corresponding CG configuration is considered as invalid, e.g., a TAT for the CG configuration expires.

In one example, the timer may be stopped when the UE receives an indication from the NW. In one aspect, the indication may be an RRCResume, an RRCSetup, an RRCRelease, an RRCRelease with a SuspendConfig, an RRCReestablishment, and/or an RRCReject message, etc. The indication may be a PDCCH addressed to an RNTI (e.g., a C-RNTI, a CS-RNTI, a dedicated RNTI, an RNTI for the SDT, and/or an RNTI for the CG). The indication may indicate to the UE to terminate the SDT procedure and/or the subsequent transmission period, e.g., based on a field of the indication. The indication may indicate to the UE to initiate an RRC procedure (e.g., an RRC connection resume procedure, an RRC establishment procedure, and/or an RRC reestablishment procedure). The indication may indicate to the UE to switch/fallback the types for the SDT, e.g., the types may be an RA-based SDT, a CG-based SDT, a 2-step RA, a 4-step RA, etc.

In one example, the timer may be stopped when the UE receives a response from the NW. In one aspect, the response may be a MSG2/MSG4/MSGB and/or a response for a UL transmission via the CG resource. In one aspect, the response may be used for the contention resolution, e.g., for an RA procedure. In one aspect, the response may include an ACK/NACK, e.g., for a UL transmission via the CG resource. In one aspect, the response may contain a UL grant/DL assignment for a new transmission/retransmission. The response may be a PDCCH addressed to an RNTI (e.g., a C-RNTI, a CS-RNTI, a dedicated RNTI, an RNTI for the SDT, and/or an RNTI for the CG). In one aspect, the response may indicate a UL grant for a new transmission for the HARQ process used for the transmission of a UL transmission for small data (e.g., the UL message). In one aspect, the response may include a specific command, e.g., a TA command MAC CE. In one aspect, the response may be an RRCResume, an RRCSetup, an RRCRelease, an RRCRelease with a SuspendConfig, an RRCReestablishment, and/or an RRCReject, etc.

In one example, the timer may be stopped upon a cell selection or a re-selection. In one example, the timer may be stopped upon abortion of a connection establishment by upper layers. In one example, the timer may be stopped upon an RNA update. In one example, the timer may be stopped when the UE changes the serving cell to another cell or when the UE camps on a new (suitable/acceptable) cell. For example, the timer may be stopped when/after the UE establishes/resumes an RRC connection from the RRC_INACTIVE state on a cell that is different from the cell where the CG configuration was provided. In one example, the timer may be stopped when the UE initiates an RRC re-establishment procedure. For example, the timer may be stopped when the UE sends an RRCReestablishmentRequest to the NW. In one example, the timer may be stopped when the UE is indicated, by the NW, to perform a carrier switching (e.g., from the NUL to the SUL, or vice versa). In one example, the timer may be stopped when the UE is indicated, by the NW, to perform a (UL/DL) BWP switching.

Upon Expiry of the Timer

In one example, upon expiry of the timer, the UE may stay in the RRC_INACTIVE state. In one example, upon expiry of the timer, the UE may initiate an RRC establishment procedure, e.g., via an RRCSetupRequest. In one example, upon expiry of the timer, the UE may initiate an RRC reestablishment procedure, e.g., via an RRCRestablishmentRequest. In one example, upon expiry of the timer, the UE may initiate an RRC connection resume procedure, e.g., via an RRCResumeRequest. In one example, upon expiry of the timer, the UE may release/suspend a CG configuration (to which the timer corresponds). In one example, upon expiry of the timer, the UE may perform retransmission based on a CG resource/configuration (to which the timer corresponds).

Assumptions for SDT

In some implementations, some assumptions for the SDT are introduced in the following with more details. In one example, the SDT may be supported as a baseline for the RA-based SDT and the CG-based SDT schemes. In one example, stored “configuration” in the UE Context may be used for the RLC bearer configuration. In one example, the 2-step RACH or the 4-step RACH may be applied to the RA-based SDT in the RRC_INACTIVE state. In one example, the UL small data may be sent in an MSGA of the 2-step RACH and/or an MSG3 of the 4-step RACH. In one example, the SDT may be configured by the NW on a per-RB (e.g., one SRB/DRB) basis. In one example, data volume threshold may be used for the UE to decide whether to perform/select the SDT procedure (e.g., initiating the SDT procedure, initiating the RA procedure for the SDT, and/or initiating the SDT procedure with the CG) or perform/select the non-SDT procedure (e.g., initiating the RA procedure for a CCCH logical channel). In one example, UL/DL transmission following the UL SDT without transitioning to the RRC_CONNECTED state (e.g., from the RRC_INACTIVE state) may be applied. In one example, when the UE is in the RRC_INACTIVE state, the UE may send/receive one or multiple UL and DL packets as part of the same SDT procedure without transitioning to the RRC_CONNECTED state (e.g., the UE may remain in the RRC_INACTIVE state).

In one example, when the UE receives an RRC release message (with a suspend configuration), the UE may perform at least one of the following:

the MAC entity may be reset, and default RB configuration may be released;
the RLC entities for the SRB1 may be re-established; and
the SRBs and DRBs may be suspended except for the SRB0;

In one example, upon initiating the SDT procedure (e.g., for the first transmission of small data), the UE may re-establish at least the PDCP entities (for the SDT) and/or resume the RBs (for the SDT).

In one example, the first UL message of the SDT (e.g., the MSG3 for the 4-step RACH, the MSGA for the 2-step RACH and/or the CG transmission) may include the following (which may depend on the size of the message):

CCCH message

In one example, the LCP may be used to determine the priority of the content that may include at least one of the following:

data from one or more RBs that are configured by the NW for the SDT;

### MAC CEs (e.g., a BSR, a PHR, etc.); and

padding bits.

In one example, the CCCH message may contain a ResumeMAC-I that is generated using the stored security key for an RRC integrity protection In one example, for the CG-based SDT, the configuration of the CG resource for a UL SDT may be contained in the RRCRelease message. In one example, for CG-based SDT, a TA timer (e.g., a cg-SDT-TimeAlignmentTimer) for the TA maintenance specified for the CG based SDT in the RRC_INACTIVE state may be applied. The TA timer may be configured together with the CG configuration in the RRCRelease message. In one example, for CG-based SDT, the configuration of the CG resource for the SDT may be valid only in the same serving cell (e.g., the configuration of the CG resource for the SDT may be invalid if the UE camps on another cell).

In one example, for CG-based SDT, the UE may use the CG-based SDT if at least one of the following criteria is fulfilled:

(1) user data is smaller than the data volume threshold;
(2) the CG resource is configured and valid; and
(3) the UE has the valid TA.

In one example, for the CG-based SDT, an association between the CG resources and the SSBs may be required for the CG-based SDT. In one example, for the CG-based SDT, an SS-RSRP threshold may be configured for the SSB selection. The UE may select one of the SSB with an SS-RSRP above the threshold and select the associated CG resource for the UL data transmission. In one example, for the CG-based SDT, the CG-SDT resource configuration may be provided to the UE(s) in the RRC_CONNCECTD state by the RRCRelease message. In one example, for the CG-based SDT, the CG resources (e.g., PUSCH resources) may be separately configured for the NUL and the SUL. In one example, for the CG-based SDT, an RRCRelease message may be used to reconfigure or release the CG-SDT configuration/resources while the UE is in the RRC_INACTIVE state. In one example, for the CG-based SDT, the subsequent data transmission may use the CG resource or the DG (e.g., dynamic grant addressed to UE's C-RNTI/CS-RNTI). The C-RNTI/CS-RNTI may be the same as the previous C-RNTI/CS-RNTI or may be configured explicitly by the NW. In one example, for the CG-based SDT, a TA timer (e.g., a cg-SDT-TimeAlignmentTimer) may be started upon receiving the TA configuration from the BS, e.g., via an RRCrelease message, and may be (re)started upon reception of the TA command. In one example, for the CG-based SDT, the UE may release the CG configuration/resources when the TAT expires in the RRC_INACTIVE state.

In one example, for the RA-based SDT, up to two preamble groups (corresponding to two different payload sizes for the MSGA/MSG3) may be configured by the NW. In one example, for the RA-based SDT, upon successful completion of the contention resolution, the UE may monitor the C-RNTI. In one example, for the RA-based SDT, the RACH resource, (e.g., a combination of the RO and a preamble), may be different between the SDT (e.g., the RA for the SDT) and the non-SDT (e.g., the RA for the CCCH or the RA for the RRC connection resume).

In one example, for the RA-based SDT, the RRCRelease message may be sent at the end to terminate the SDT procedure (e.g., based on the perspective of the RRC). Specifically, the RRCRelease sent at the end of the SDT may contain the CG resource.

In one example, an RSRP threshold (e.g., an sdt-RSRP-Threshold) may be used to select between the SDT (e.g., initiating the SDT procedure, initiating the RA procedure for SDT, and/or initiating the SDT procedure with the CG) and non-SDT procedure (e.g., initiating the RA procedure for the CCCH logical channel).

In one example, for the SDT, the UE may perform the UL carrier selection (e.g., the UL selection and the SUL selection).

In one example, if the CG-SDT resources are configured on the selected UL carrier and are valid, the CG-based SDT may be selected to perform. Otherwise,

if the 2-step RA resources (for the SDT) are configured on the UL carrier and criteria to select the 2-step RA (for the SDT) is met, the 2-step RA type (for the SDT) may be chosen;
else If the 4-step RA resources (for the SDT) are configured on the UL carrier and criteria to select the 4-step RA (for the SDT) is met, the 4-step RA type may be chosen;
else the UE does not perform the SDT procedure (e.g., the UE may perform the RRC connection resume procedure);
if both the 2-step RA (for the SDT) and the 4-step RA resources (for the SDT) are configured on the UL carrier, the RA type selection (e.g., the 2-step RA type selection and the 4-step RA type selection) may be performed based on a RSRP threshold (e.g., an sdt-MSGA-RSRP-Threshold).

In one example, except for the DRB, the SRB1 and the SRB2 may be configured for the SDT, e.g., for carrying the RRC message(s) and/or the NAS message(s). Upon initiating the SDT procedure and/or the RRC Resume procedure for the SDT initiation (e.g., for the first SDT transmission), the UE may resume the SRB (e.g., the SRB1, the SRB2, and/or the SRB3) that is configured for the SDT, e.g., in addition to the DRBs that are configured for the SDT.

In one example, a specific SS may be supported for monitoring the PDCCH addressed to the C-RNTI after a successful completion of the RACH procedure during the RA-SDT.

In one example, an RSRP threshold (e.g., an sdt-RSRP-Threshold) may be used to select between the SDT and the non-SDT procedure, if configured (an RSRP refers to the same RSRP measured for the carrier selection). In one example, an RSRP threshold (e.g., an sdt-RSRP-Threshold) to select between the SDT and the non-SDT procedure may be used for both the CG-SDT and the RA-SDT. In one example, an RSRP threshold (e.g., an sdt-RSRP-Threshold) to select between the SDT and the non-SDT procedure may be the same for both the CG-SDT and the RA-SDT.

In one example, an RSRP threshold for the carrier selection (e.g., an sdt-RSRP-ThresholdSSB-SUL) may be specific to the SDT (e.g., separately configured for the SDT). Specifically, this may be optional for the NW. In one example, an RSRP threshold for the RA type selection (an sdt-MSGA-RSRP-Threshold) may be specific to the SDT (e.g. separately configured for the SDT).

In one example, a data volume threshold (e.g., an sdt-DataVolumeThreshold) may be the same for the CG-SDT and the RA-SDT.

In one example, switching/fallback from the SDT procedure to the non-SDT procedure (e.g., an RRC connection resume procedure) may be applied based on some criteria. In one example, switching/fallback from the CG-SDT to the RA-SDT may be applied based on some criteria.

In one example, the UE may switch from the SDT procedure to the non-SDT procedure (e.g., an RRC connection resume procedure) in following cases:

in one aspect, the UE may receive an indication from the NW to switch to the non-SDT procedure. For example, the NW may send an RRCResume; and may send an indication in a RAR/fallbackRAR/DCI to switch to the non-SDT procedure; and/or
in one aspect, an initial UL transmission (in the MSGA/MSG3/CG resources) fails to reach a configured number of times.

In one example, the UE may perform a PDCP re-establishment implicitly, e.g., without an explicit indication for the PDCP re-establishment, when the UE initiates the SDT procedure.

In one example, an SR resource (e.g., a PUCCH resource for the SR) may not be configured for the SDT. When the BSR is triggered by SDT data, the UE may trigger the RA because the SR resource is not available.

In one example, an SDT failure detection timer may be started upon an initiation of the SDT procedure. In one example, upon an SDT failure detection timer expiry, the UE may transition to an IDLE state and/or attempts to initiate an RRC connection setup.

In one example, CG resources for the SDT may be configured at the same time on the NUL and the SUL. In one example, the UE may start a timer after a UL transmission, e.g., for the CG-SDT. In one example, CG resources for the SDT may be configured on BWPs other than the initial BWP. In one example, CG resources per CG configuration may be associated with a set of SSB(s) configured by an explicit signaling.

In one example, the specific SS may be a CSS to the UEs performing the RA-SDT. In one example, a USS may be configured for UEs performing the CG-SDT.

In one example, the UE may monitor paging after the UE initiates the SDT for SI change and/or PWS.

In one example, for the CG-based SDT, the SSB-to-PUSCH resource mapping within the CG configuration may be implicitly defined. In one aspect, the ordering of the SSB and the CG PUSCH resources may be captured, as specified in 3GPP RANI specifications (e.g., TS 38.213). In one aspect, a PUSCH resource may refer to a transmission occasion and a DMRS resource used for a PUSCH transmission.

In one example, the SSB subset for an RSRP-based TA validation may be determined at least based on a configured absolute RSRP threshold. The SSB subset may be at least one of the following:

within a set of SSBs that are configured per CG configuration;
within a set of SSBs that are configured for all CG configurations;
within a set of all SSBs that are actually transmitted as indicated in an SIB1; and
highest N SSBs that are measured to derive the subset for one UE across all CG configurations.

RA Procedure

In some implementations, two types of RA procedure may be supported, e.g., the 4-step RA type with the MSG1 and the 2-step RA type with the MSGA. Both types of RA procedure may support the CBRA and the CFRA.

In some implementations, the UE may select the type of RA at an initiation of the RA procedure based on the NW's configuration. More details are introduced in the following.

In one example, when CFRA resources are not configured, an RSRP threshold may be used by the UE to select between the 2-step RA type and the 4-step RA type. In one example, when CFRA resources for the 4-step RA type are configured, the UE may perform the RA with the 4-step RA type. In one example, when CFRA resources for the 2-step RA type are configured, the UE may perform the RA with the 2-step RA type.

In some implementations, the NW may not configure CFRA resources for the 4-step RA type and the 2-step RA type at the same time for a BWP. The CFRA with the 2-step RA type is only supported for such handover.

In some implementations, the MSG1 of the 4-step RA type includes a preamble on a PRACH. After transmitting the MSG1, the UE may monitor for a response from the NW within a configured window. For the CFRA, a dedicated preamble for the MSG1 transmission is assigned by the NW and upon receiving an RAR from the NW, the UE may end the RA procedure. For the CBRA, upon reception of the RAR, the UE may send the MSG3 using the UL grant scheduled in the response and monitor contention resolution. If the contention resolution is not successful after MSG3 (re)transmission(s), the UE may switch to the MSG1 transmission.

In some implementations, the MSGA of the 2-step RA type includes a preamble on a PRACH and a payload on a PUSCH. After transmitting the MSGA, the UE may monitor for a response from the NW within a configured window. For the CFRA, a dedicated preamble and a PUSCH resource are configured for the MSGA transmission and upon receiving the NW's response, the UE may end the RA procedure. For the CBRA, if the contention resolution is successful upon receiving the NW's response, the UE may end the RA procedure; alternatively, if a fallback indication is received in the MSGB, the UE may perform the MSG3 transmission using the UL grant scheduled in the fallback indication and monitor the contention resolution. If the contention resolution is not successful after MSG3 (re)transmission(s), the UE may switch to the MSGA transmission.

In some implementations, if the RA procedure with the 2-step RA type is not completed after a number of the MSGA transmissions, the UE may be configured to switch to the CBRA with the 4-step RA type.

CG

In some implementations, with configured grants, the BS can allocate UL resources for the initial HARQ transmissions to UEs. Two types of configured UL grants are defined in the following: with a type 1 (e.g., a CG type 1), an RRC directly provides the configured UL grant (including the periodicity);

with a type 2 (e.g., a CG type 2), RRC defines the periodicity of the configured UL grant while a PDCCH addressed to a CS-RNTI may either signal and activate the configured UL grant, or deactivate it. Specifically, a PDCCH addressed to a CS-RNTI indicates that the UL grant may be implicitly reused according to the periodicity defined by the RRC until the CG is deactivated.

In some implementations, the NW and/or the RRC may configure the following parameters when the CG Type 1 is configured:

cs-RNTI: A CS-RNTI for retransmission;
periodicity: A periodicity of the configured grant Type 1;
timeDomainOffset: An offset of a resource with respect to SFN=0 in time domain;
timeDomainAllocation: Allocation of configured UL grant in time domain which includes a
startSymbolAndLength (e.g., SLIV in 3GPP TS 38.214);
nrofHARQ-Processes: a number of HARQ processes for configured grant.

In some implementations, upon configuration of a CG Type 1 for a serving cell by upper layers, the UE (or the MAC entity) may perform at least one of the following actions/operations:

store the UL grant provided by upper layers as a configured UL grant (for the indicated serving cell); and
initialize or re-initialize the configured UL grant to start in the symbol according to the timeDomainOffset and ‘S’ (as derived from the SLIV that is specified in 3GPP TS 38.214), and to reoccur with the periodicity.

RRC Connection Resume Procedure

In some implementations, the purpose of the RRC connection resume procedure may be to resume a suspended RRC connection, including resuming SRB(s) and DRB(s) or performing an RNA update.

In some implementations, the UE may initiate the RRC connection resume procedure when upper layers or AS (when responding to RAN paging, upon triggering RNA updates while the UE is in the RRC_INACTIVE state) request the resume of a suspended RRC connection.

In some implementations, the suspension of the RRC connection may be initiated by the NW. When the RRC connection is suspended, the UE may store the UE Inactive AS context and any configuration received from the NW and transit to the RRC_INACTIVE state. The RRC message to suspend the RRC connection may be integrally protected and ciphered.

In some implementations, the resumption of a suspended RRC connection may be initiated by upper layers when the UE needs to transit from the RRC_INACTIVE state to the RRC_CONNECTED state or by the RRC layer to perform a RNA update or by the RAN paging from the Next-Generation Radio Access Network (NG-RAN). When the RRC connection is resumed, the NW may configure the UE according to the RRC connection resume procedure based on the stored UE Inactive AS context and any RRC configuration received from the NW. The RRC connection resume procedure re-activates AS security and re-establishes SRB(s) and DRB(s).

In some implementations, in response to a request to resume the RRC connection, the NW may resume the suspended RRC connection and have the UE transition to the RRC_CONNECTED state or reject the request to resume and have the UE transition to the RRC_INACTIVE state (with a wait timer), or directly re-suspend the RRC connection and have the UE transition to the RRC_INACTIVE state, or directly release the RRC connection and have the UE transition to the RRC_IDLE state, or instruct the UE to initiate a NAS level recovery (in a case that the NW sends an RRC setup message). More details of the RRC connection resume procedure may be found in 3GPP TS 38.331 V16.4.1.

Radio Protocol Architecture

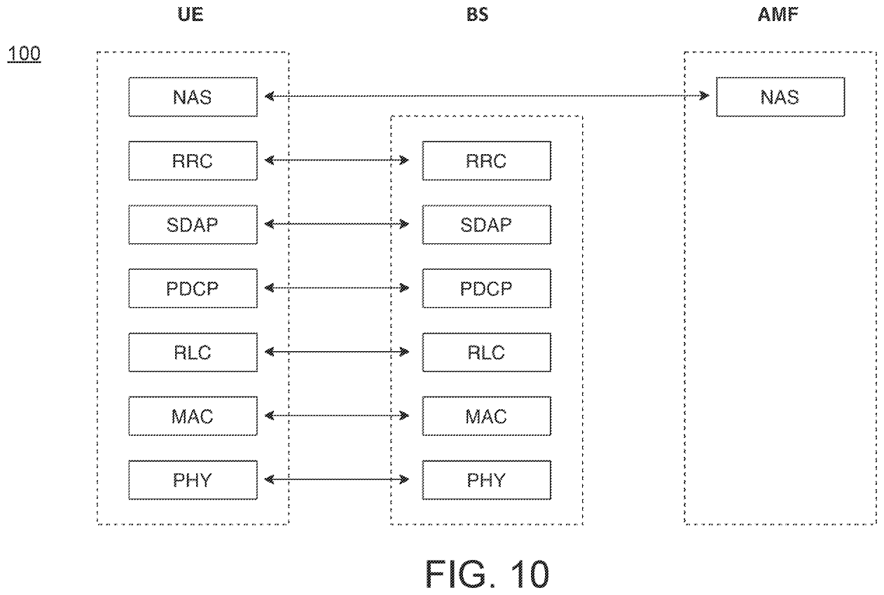

FIG. 10 illustrates a diagram of a radio protocol stack 100, according to an example implementation of the present disclosure. In some implementations, as shown in FIG. 10, the radio protocol stack 100 may include several sublayers, e.g., NAS, RRC, SDAP, PDCP, RLC, MAC, and/or PHY layers. Different layers may be responsible for different functions. The functions may be separately related to the control plane or the user plane.

In some implementations, for the control plane, control-relevant information may be exchanged between the NW and the UE. The establishment and management of sessions may occur at the highest layer in the control plane called non-access stratum (NAS). The next layer, e.g., the radio resource control (RRC), may exchange control information with the device to set important parameters for the session.

In some implementations, for the user plane, the NW and the UE may exchange user data. The highest layers may be the application and IP layers and refer to the worldwide web and other applications running on it. Data may go through the SDAP, a new protocol layer for QoS management. The SDAP layer for QoS management in the user plane may provide mapping between QoS flow and DRBs and marking for QoS flow IDs in DL and UL packets all the way to the 5G core.

In some implementations, the IP header may be replaced with a 5G equivalent at the PDCP layer. The RLC layer may organize the data and retransmission, if necessary. Prioritization and hybrid automated retransmission requests may take place at the MAC layer.

In some implementations, the last layer in the protocol structure may be the PHY. This layer may include aspects relevant for the communication channel between the UE and the core NW as well as other aspects like modulation and beamforming.

In some implementations, data may flow between the RLC, MAC, and PHY layers of the stack through channels. In one example, the logical channels may be between the RLC and the MAC layers. These channels may define the type of data that can be transferred. In one example, the transport channels may carry information from the MAC layer to the PHY layer. These channels may define how the information can be carried to the physical layer and the characteristics of the data.

In some implementations, the physical layer may communicate directly with the UE through the physical channels. Physical channel characteristics may include timing, access protocols, and data rates.

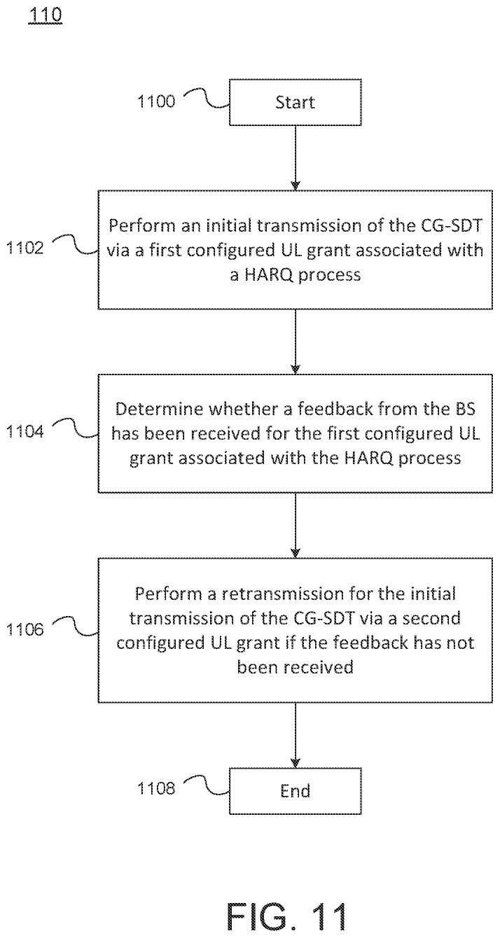

FIG. 11 illustrates a flowchart of a procedure 110 for a UE to perform a CG-SDT, according to an example implementation of the present disclosure. In some implementations, actions the procedure 110 are illustrated as separate actions represented as independent blocks. In some other implementations, these separate actions may not be construed as necessarily order dependent, where any two or more actions may also be performed and/or combined with each other or be integrated with other alternate methods, which is not limiting the scope of the implementation. Moreover, in some other implementations, one or more of the actions may be adaptively omitted.

As shown in FIG. 11, the procedure 110 for the UE includes the following actions:

Action 1100: Start.

Action 1102: Perform an initial transmission of the CG-SDT via a first configured UL grant associated with a HARQ process.

Action 1104: Determine whether a feedback from the BS has been received for the first configured UL grant associated with the HARQ process.

Action 1106: Perform a retransmission for the initial transmission of the CG-SDT via a second configured UL grant if the feedback has not been received.

Action 1108: End.

In some implementations, in action 1102, the UE may perform the initial transmission of the CG-SDT via the first configured UL grant that is associated with the HARQ process. In some implementations, the initial transmission of the CG-SDT comprises a CCCH message.

In action 1104, the UE may determine whether the feedback from the BS has been received for the first (or the previous) configured UL grant associated with the HARQ process. In some implementations, the feedback is received on a PDCCH addressed to a C-RNTI.

In action 1106, the UE may perform the retransmission for the initial transmission of the CG-SDT via the second configured UL grant if the feedback has not been received. In some implementations, the retransmission for the initial transmission of the CG-SDT is performed if the feedback is not received and a configured CG-SDT retransmission timer is not running.

In some implementations, a MAC layer of the UE indicates a failure of performing an SDT procedure to an RRC layer of the UE if a configured grant timer for the HARQ process expires and the feedback has not been received after the initial transmission of the CG-SDT.

In some implementations, the procedure 110 may further configure the UE to stop a CG-SDT retransmission timer for the HARQ process if the UE receives a specific UL grant. Specifically, the specific UL grant is received on a PDCCH that is addressed to a C-RNTI.

In some implementations, the procedure 110 may further configure the UE to stop a configured grant timer for the HARQ process if the UE receives a specific UL grant. Specifically, the specific UL grant is received on a PDCCH that is addressed to a C-RNTI.

In some implementations, the procedure 110 may further configure the UE to start or restart a CG-SDT retransmission timer for the HARQ process when the initial transmission of the CG-SDT or the retransmission for the initial transmission of the CG-SDT is performed.

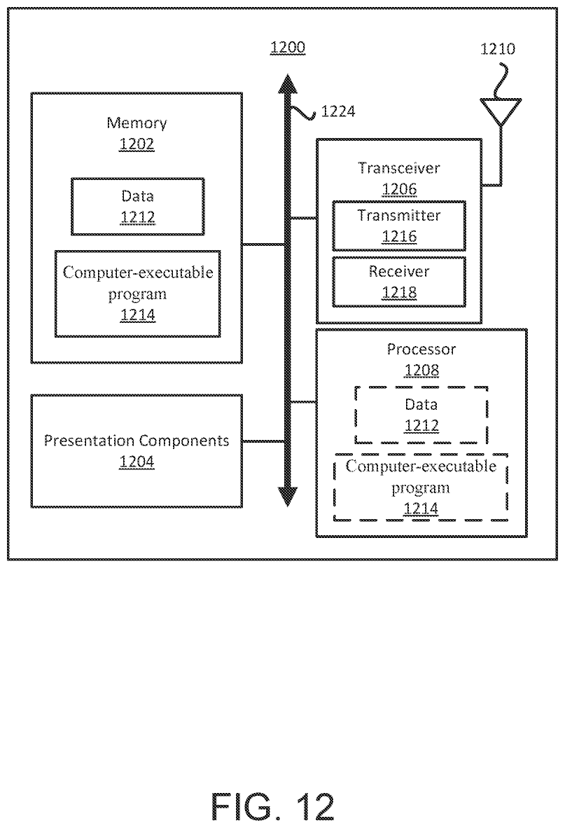

Please refer to FIG. 12, which illustrates a block diagram of a node 1200 for wireless communication according to an implementation of the present disclosure. As illustrated in FIG. 12, the node 1200 includes a transceiver 1206, a processor 1208, a memory 1202, one or more presentation components 1204, and at least one antenna 1210. The node 1200 may also include a Radio Frequency (RF) spectrum band module, a BS communications module, an NW communications module, and a system communications management module, input/output (I/O) ports, I/O components, and power supply (not explicitly illustrated in FIG. 12). Each of these components may be in communication with each other, directly or indirectly, over one or more buses 1224. The node 1200 may be a UE, an NW, a cell/BS or any operating entity in the wireless communication system that performs various functions disclosed herein, for example, with reference to FIG. 11.

The transceiver 1206 includes a transmitter 1216 (e.g., transmitting/transmission circuitry) and a receiver 1218 (e.g., receiving/reception circuitry) and may be configured to transmit and/or receive time and/or frequency resource partitioning information. The transceiver 1206 may be configured to transmit in different types of subframes and slots, including, but not limited to, usable, non-usable and flexibly usable subframes and slot formats. The transceiver 1206 may be configured to receive data and control channels.

The node 1200 may include a variety of computer-readable media. Computer-readable media may be any available media that may be accessed by the node 1200 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information such as computer-readable.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal such as a carrier wave or other transport mechanism and include any information delivery media.

The term “modulated data signal” may refer to a signal that has one or more of its characteristics set or changed in such a manner as to encode information in the signal. By way of example, and not limitation, communication media may include wired media, such as a wired NW or direct-wired connection, and wireless media, such as acoustic, RF, infrared, and other wireless media. Combinations of any of the previous disclosure should also be included within the scope of computer-readable media.

The memory 1202 may include computer-storage media in the form of volatile and/or non-volatile memory. The memory 1202 may be removable, non-removable, or a combination thereof. For example, the memory 1002 may include solid-state memory, hard drives, optical-disc drives, etc.

As illustrated in FIG. 12, the memory 1202 may store a computer-executable (or readable) program 1214 (e.g., software codes or instructions) that are configured to, when executed, cause the processor 1208 to perform various functions disclosed herein, for example, with reference to FIG. 11. Alternatively, the computer-executable program 1214 may not be directly executable by the processor 1208 but may be configured to cause the node 1200 (e.g., when compiled and executed) to perform various functions disclosed herein.

The processor 1208 (e.g., having processing circuitry) may include an intelligent hardware device, a CPU, a microcontroller, an ASIC, etc. The processor 1208 may include memory. The processor 1208 may process the data 1212 and the computer-executable program 1214 received from the memory 1202, and information received via the transceiver 1206, the baseband communications module, and/or the NW communications module. The processor 1208 may also process information to be sent to the transceiver 1206 for transmission through the antenna 1210 to the NW communications module for subsequent transmission to a CN.

One or more presentation components 1204 may present data to a person or other device. Examples of presentation components 1204 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

What is claimed is:

1. A method for a User Equipment (UE) to perform a Configured Grant-based Small Data Transmission (CG-SDT) to a Base Station (BS), the method comprising:
performing an initial transmission of the CG-SDT via a first configured Uplink (UL) grant associated with a Hybrid Automatic Repeat Request (HARQ) process;
determining whether a feedback from the BS has been received for the first configured UL grant associated with the HARQ process; and
performing a retransmission for the initial transmission of the CG-SDT via a second configured UL grant if the feedback has not been received.

2. The method of claim 1, wherein the initial transmission of the CG-SDT comprises a Common Control Channel (CCCH) message.

3. The method of claim 1, wherein the feedback is received on a Physical Downlink Control Channel (PDCCH) addressed to a Cell-Radio Network Temporary Identifier (C-RNTI).

4. The method of claim 1, wherein the retransmission for the initial transmission of the CG-SDT is performed if the feedback is not received and a configured CG-SDT retransmission timer is not running.

5. The method of claim 1, wherein a Medium Access Control (MAC) layer of the UE indicates a failure of performing a Small Data Transmission (SDT) procedure to a Radio Resource Control (RRC) layer of the UE if a configured grant timer for the HARQ process expires and the feedback has not been received after the initial transmission of the CG-SDT.

6. The method of claim 1, further comprising:
stopping a CG-SDT retransmission timer for the HARQ process if the UE receives a specific UL grant.

7. The method of claim 6, wherein the specific UL grant is received on a Physical Downlink Control Channel (PDCCH) addressed to a Cell-Radio Network Temporary Identifier (C-RNTI).

8. The method of claim 1, further comprising:
stopping a configured grant timer for the HARQ process if the UE receives a specific UL grant.

9. The method of claim 8, wherein the specific UL grant is received on a Physical Downlink Control Channel (PDCCH) addressed to a Cell-Radio Network Temporary Identifier (C-RNTI).

10. The method of claim 1, further comprising:
starting or restarting a CG-SDT retransmission timer for the HARQ process when the initial transmission of the CG-SDT or the retransmission for the initial transmission of the CG-SDT is performed.

11. A User Equipment (UE) in a wireless communication system for performing a Configured Grant-based Small Data Transmission (CG-SDT) to a Base Station (BS), the UE comprising:
at least one processor; and
at least one memory coupled to the at least one processor, wherein the at least one memory stores a computer-executable program that, when executed by the at least one processor, causes the UE to:
perform an initial transmission of the CG-SDT via a first configured Uplink (UL) grant associated with a Hybrid Automatic Repeat Request (HARQ) process;
determine whether a feedback from the BS has been received for the first configured UL grant associated with the HARQ process; and
perform a retransmission for the initial transmission of the CG-SDT via a second configured UL grant if the feedback has not been received.

12. The UE of claim 11, wherein the initial transmission of the CG-SDT comprises a Common Control Channel (CCCH) message.

13. The UE of claim 11, wherein the feedback is received on a Physical Downlink Control Channel (PDCCH) addressed to a Cell-Radio Network Temporary Identifier (C-RNTI).

14. The UE of claim 11, wherein the retransmission for the initial transmission of the CG-SDT is performed if the feedback is not received and a configured CG-SDT retransmission timer is not running.

15. The UE of claim 11, wherein a Medium Access Control (MAC) layer of the UE indicates a failure of performing a Small Data Transmission (SDT) procedure to a Radio Resource Control (RRC) layer of the UE if a configured grant timer for the HARQ process expires and the feedback has not been received after the initial transmission of the CG-SDT.

16. The UE of claim 11, wherein the computer-executable program, when executed by the at least one processor, further causes the UE to:
stop a CG-SDT retransmission timer for the HARQ process if the UE receives a specific UL grant.

17. The UE of claim 16, wherein the specific UL grant is received on a Physical Downlink Control Channel (PDCCH) addressed to a Cell-Radio Network Temporary Identifier (C-RNTI).

18. The UE of claim 11, wherein the computer-executable program, when executed by the at least one processor, further causes the UE to:
stop a configured grant timer for the HARQ process if the UE receives a specific UL grant.

19. The UE of claim 18, wherein the specific UL grant is received on a Physical Downlink Control Channel (PDCCH) addressed to a Cell-Radio Network Temporary Identifier (C-RNTI).

20. The UE of claim 11, wherein the computer-executable program, when executed by the at least one processor, further causes the UE to:
start or restart a CG-SDT retransmission timer for the HARQ process when the initial transmission of the CG-SDT or the retransmission for the initial transmission of the CG-SDT is performed.
